(19) United States
(12) Patent Application Publication
(10) Pub. No.: US 2026/0060492 A1
(43) Pub. Date: Mar. 5, 2026

(54) SANITIZING STATION FOR TIDYING ROBOT

(71) Applicant: Clutterbot, Inc., Claymont, DE (US)

(72) Inventor: Justin David Hamilton, Wellington (NZ)

(73) Assignee: Clutterbot, Inc., Claymont, DE (US)

(21) Appl. No.: 19/313,819

(22) Filed: Aug. 28, 2025

Related U.S. Application Data
(60) Provisional application No. 63/688,571, filed on Aug. 29, 2024.

(51) Int. Cl. A47L 9/00; A47L 9/02

(52) U.S. Cl. CPC A47L 9/0009; A47L 9/02; A47L 2201/024

(57) ABSTRACT

A sanitizing station for a robot includes various components, such as a water-tight door, water reservoir, water heater, drain, recirculation pump, water spray nozzles, detergent dispenser, wastewater filter, wastewater pump, wastewater outlet, drying air intake, drying fan, drying air conduits, air outlet conduit, and drying air outlet. The station is designed to sanitize robots by providing a water-tight environment for washing with heated water and detergent, followed by rinsing, filtering wastewater, pumping it out, and using drying fans and air conduits to remove moisture from the robot's surface.

This application claims the benefit of U.S. provisional patent application Ser. No. 63/688,571, filed on Aug. 29, 2024, the contents of which are incorporated herein by reference in their entirety.

### BACKGROUND

Obstructions or objects underfoot represent not only a nuisance but also a safety hazard. Thousands of people each year are injured in a fall at home. A floor cluttered with loose objects may represent a danger, but many people have limited time in which to address the clutter in their homes. Automated cleaning or tidying robots may represent an effective solution.

Tidying robots conventionally organize objects into standard categories based on an object's type and other attributes that may be determined with classification. However, conventional robotic tidying solutions may be limited in their capabilities, and may be unable to autonomously complete a comprehensive cleaning operation without additional manual work by the user.

There is, therefore, a need for a general purpose tidying robot capable of complex and comprehensive housework operations.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B illustrate a sanitizing station 100 in accordance with one embodiment.

FIG. 2 illustrates a side elevation view of a sanitizing station 200 in accordance with one embodiment.

FIG. 3A and FIG. 3B illustrate a side elevation view of a tidying robot interacting with a sanitizing station 300 in accordance with one embodiment. FIG. 3A shows a side elevation view and FIG. 3B shows a top plan view.

FIG. 4A and FIG. 4B illustrate a tidying robot 400 in accordance with one embodiment. FIG. 4A shows a side elevation view and FIG. 4B shows a top plan view.

FIG. 5A and FIG. 5B illustrate a simplified side view and top view of a chassis 402 of the tidying robot 400, respectively.

FIG. 6A and FIG. 6B illustrate a left side view and a top view of a base station 600, respectively, in accordance with one embodiment.

FIG. 7A-FIG. 7I illustrate a countertop cleaning and sanitizing station use process 700 in accordance with one embodiment.

FIG. 8 illustrates a method 800 in accordance with one embodiment.

FIG. 9 illustrates a method 900 in accordance with one embodiment.

FIG. 10 illustrates a method 1000 in accordance with one embodiment.

FIG. 11A illustrates a lowered scoop position and lowered pusher position 1100a for the tidying robot 400 in accordance with one embodiment.

FIG. 11B illustrates a lowered scoop position and raised pusher position 1100b for the tidying robot 400 in accordance with one embodiment.

FIG. 11C illustrates a raised scoop position and raised pusher position 1100c for the tidying robot 400 in accordance with one embodiment.

FIG. 11D illustrates a tidying robot 400 with pusher pads extended 1100d in accordance with one embodiment.

FIG. 11E illustrates a tidying robot 400 with pusher pads retracted 1100e in accordance with one embodiment.

FIG. 12A illustrates a lowered scoop position and lowered pusher position 1200a for the tidying robot 400 in accordance with one embodiment.

FIG. 12B illustrates a lowered scoop position and raised pusher position 1200b for the tidying robot 400 in accordance with one embodiment.

FIG. 12C illustrates a raised scoop position and raised pusher position 1200c for the tidying robot 400 in accordance with one embodiment.

FIG. 13A illustrates a lowered scoop position and lowered pusher position 1300a for the tidying robot 400 in accordance with one embodiment.

FIG. 13B illustrates a lowered scoop position and raised pusher position 1300b for the tidying robot 400 in accordance with one embodiment.

FIG. 13C illustrates a raised scoop position and raised pusher position 1300c for the tidying robot 400 in accordance with one embodiment.

FIG. 14 illustrates a front drop position 1400 for the tidying robot 400 in accordance with one embodiment.

FIG. 15 illustrates a tidying robot 400 performing a front dump action 1500 in accordance with one embodiment.

FIG. 16 illustrates a tidying robotic system interaction 1600 in accordance with one embodiment.

FIG. 17 illustrates an embodiment of a robotic control system 1700 to implement components and process steps of the system described herein.

FIG. 18 illustrates sensor input analysis 1800 in accordance with one embodiment.

FIG. 19A-FIG. 19E illustrate an obstruction placement procedure 1900 in accordance with one embodiment.

FIG. 20A-FIG. 20E illustrate an obstruction placement procedure 2000 in accordance with one embodiment.

### DETAILED DESCRIPTION

A general purpose home tidying robot may operate conjunction with a sanitizing station which may be used as a location for disposal and maintenance tasks such as:
Charging the robot
Emptying the robot vacuum system
Disposing of garbage, recycling, compost, in bins
Cleaning and disinfecting the scoop, pusher pads, and pusher pad arms, gripper arm
Replacing mop pads with clean refill pads
Acquiring wipes or towels for cleaning the counter
Depositing used towels in a laundry basket

The sanitizing station for the general purpose tidying robot is used to keep the robot's end effectors (scoop, pusher pads, pusher pad arms, and gripper arm) clean between different tidying activities. This is important because some tidying activities may be interacting with clean objects and other tidying activities may be interacting with varying degrees of dirty objects.

For example, the general purpose tidying robot may execute the following tidying steps to clean the home. Note that the robot may optionally sanitize its end effectors every time it wakes up and starts a new activity.

### 1. Activity: Tidy Dirty Dishes on Counter

a. Robot picks up each dirty dish on counter using scoop and pusher arms
b. Opens kitchen garbage can with gripper and inverts dish to dump leftover food
c. Opens the dishwasher with gripper and carefully puts dish into dishwasher
d. Sanitize the general purpose tidying robot's end effectors

### 2. Activity: Tidy Clean/Empty Recycling off of Counter

a. Robot picks up clean/empty items for recycling using scoop and pusher arms
b. Avoid any recyclable containers that still have food in them
c. Opens recycling bin with gripper and drops recycling items into bin
d. Sanitize the general purpose tidying robot's end effectors

### 3. Activity: Tidy Garbage and Food Scraps off of Counter

a. Robot picks up garbage and food scraps using scoop and pusher arms
b. Open kitchen garbage can with gripper and empty scoop into garbage
c. Sanitize the general purpose tidying robot's end effectors
   4. Activity: Wipe Countertop using Cleaner Wipes
a. Robot uses pusher arms to pick up a cleaning wipe from wipe storage
b. Wipe is used to clean and sanitize the countertop in standard pattern
c. Pusher arms push the wipe and any crumbs into the scoop (often using counter edge)
d. Open kitchen garbage can with gripper and empty scoop into garbage
e. Sanitize the general purpose tidying robot's end effectors

### 5. Activity: Sweet up Dirt, Food and Garbage off the Floor

a. Sweep and scoop up dirt, bits of food and garbage off the floor
b. Open kitchen garbage can with gripper and empty scoop into garbage
c. Sanitize the general purpose tidying robot's end effectors

### 6. Activity: Tidy up Toys and Other Small Objects off the Floor

a. Pick up toys and other small objects off the floor
b. Put away toys and other small objects into bin by category
c. Sanitize the general purpose tidying robot's end effectors

### 7. Activity: Tidy Dirty Clothing off the Floor

a. Pick up dirty clothing, towels and similar objects off the floor
b. Put away dirty clothing and towels into the laundry bin
c. Sanitize the general purpose tidying robot's end effectors

### 8. Activity: Vacuum Kitchen Floor

a. Vacuum kitchen floor area following a standard pattern
b. Robot may use scoop and pusher arms to move obstacles
c. Empty robot's dirt collection bin
d. Sanitize the general purpose tidying robot's end effectors 302

The following describes the basic sanitization process for the robot's end effectors (scoop, pusher pads, pusher pad arms and the gripper arm) in the sanitization station:
Open sanitizing station door
Place scoop in sanitizing station
Close sanitizing station door
Start pre-rinse cycle
   Fill water basin
   Heat water
   Spray water
   Drain water
Start sanitization cycle
   Fill water basin
   Heat water
   Release detergent
   Spray water
   Drain water
Start 1st rinse cycle
   Fill water basin
      Heat water
      Spray water
      Drain water
Start 2nd rinse cycle
   Fill water basin
   Heat water
   Spray water
   Drain water
Drying cycle
   Heating element at bottom turned on to dry with heat
   Air fan is used to circulate air
   Heating element at bottom turned off to start cooling
   Air fan is used to circulate air
Open sanitization station door
Scoop is removed
Close sanitation station door

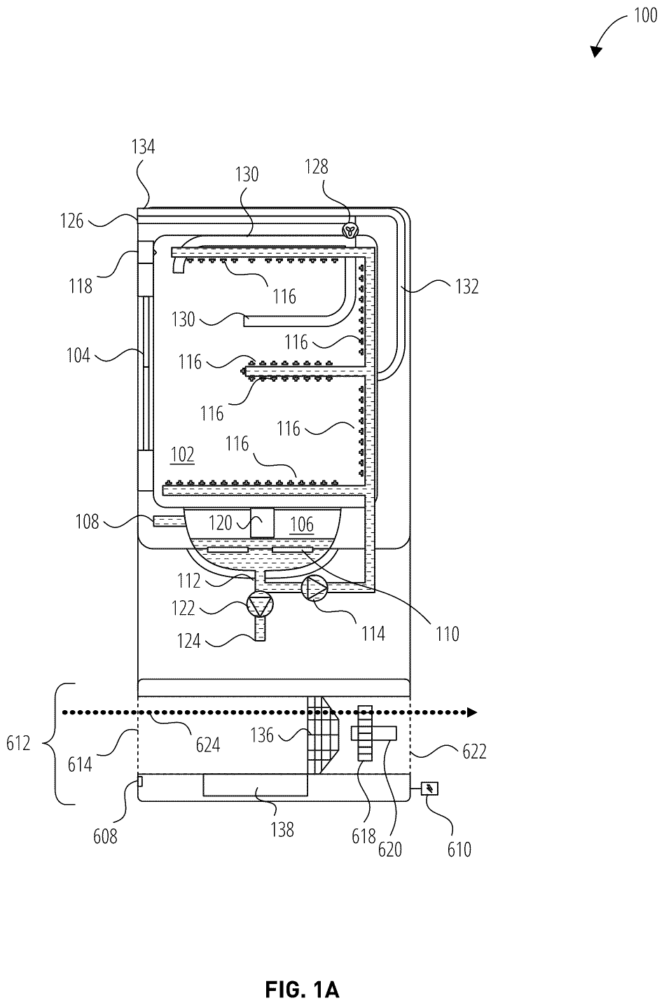

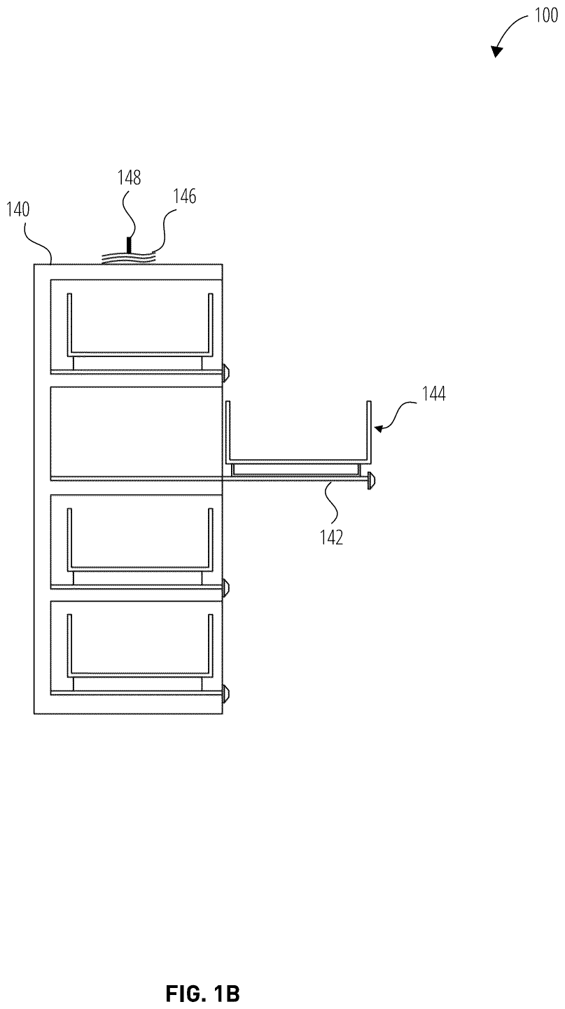

FIG. 1A and FIG. 1B illustrate a sanitizing station 100 in accordance with one embodiment. FIG. 1A illustrates a left-side elevation view and FIG. 1B illustrates a right-side elevation view. The sanitizing station 100 may also include a sanitizing chamber 102 with a water-tight door 104, a water reservoir 106 with a water intake 108, a water heater 110, and a drain 112, a recirculation pump 114, water spray nozzles 116, a detergent dispenser 118, a wastewater filter 120, a wastewater pump 122, a wastewater outlet 124, a drying air intake 126, a drying fan 128, drying air conduits 130, an air outlet conduit 132, and a drying air outlet 134.

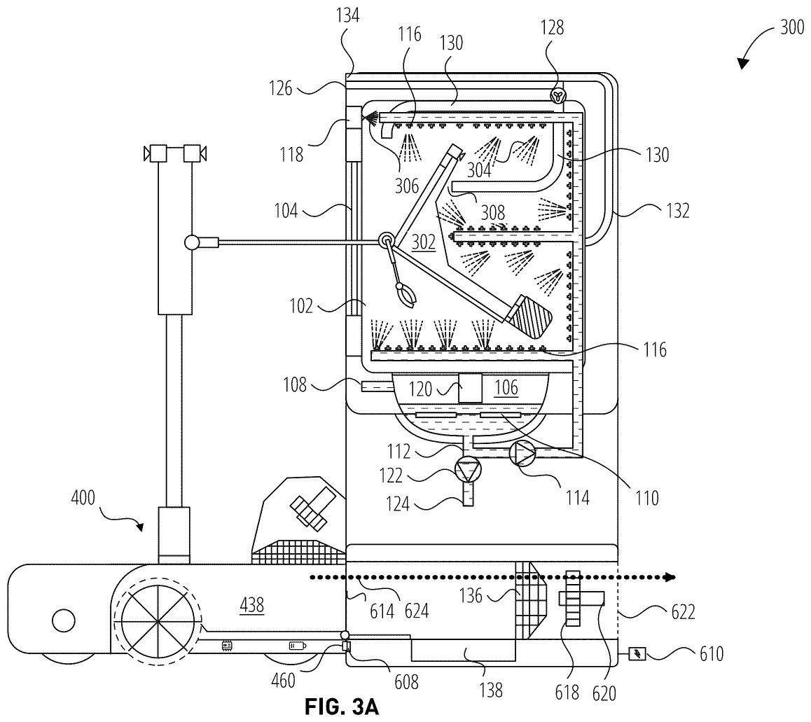

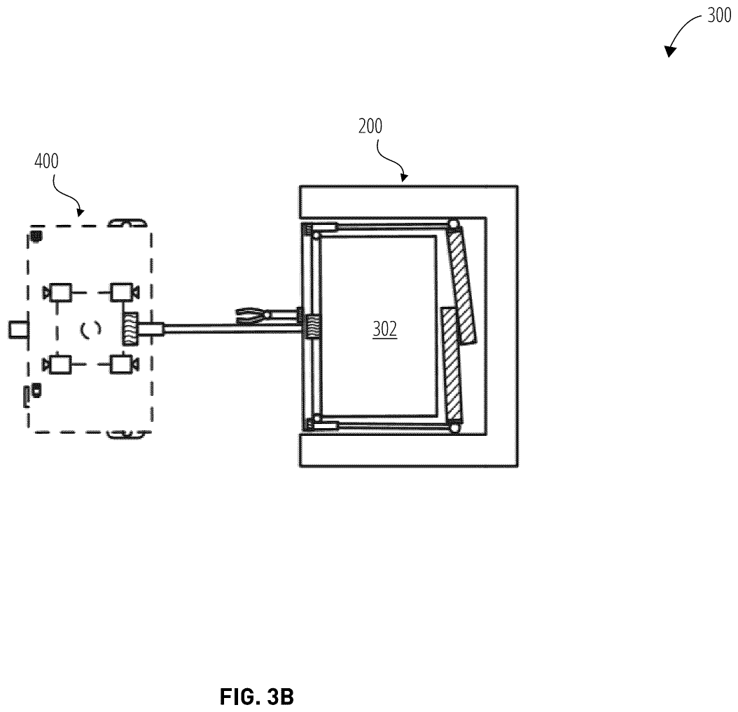

These elements of the sanitizing station 100 may be configured to interact with the tidying robot 400 as shown in and described in greater detail with respect to FIG. 3A. In brief, the sanitizing station 100 uses a water reservoir 106 at the bottom to both heat the water and to recirculate the water during the sanitation process. A wastewater filter 120 is used to catch any solid debris or particles that may be present during operation. A water heater 110 heating element at the bottom is used to both heat the water during the washing cycle, but also to heat the air during the drying cycle.

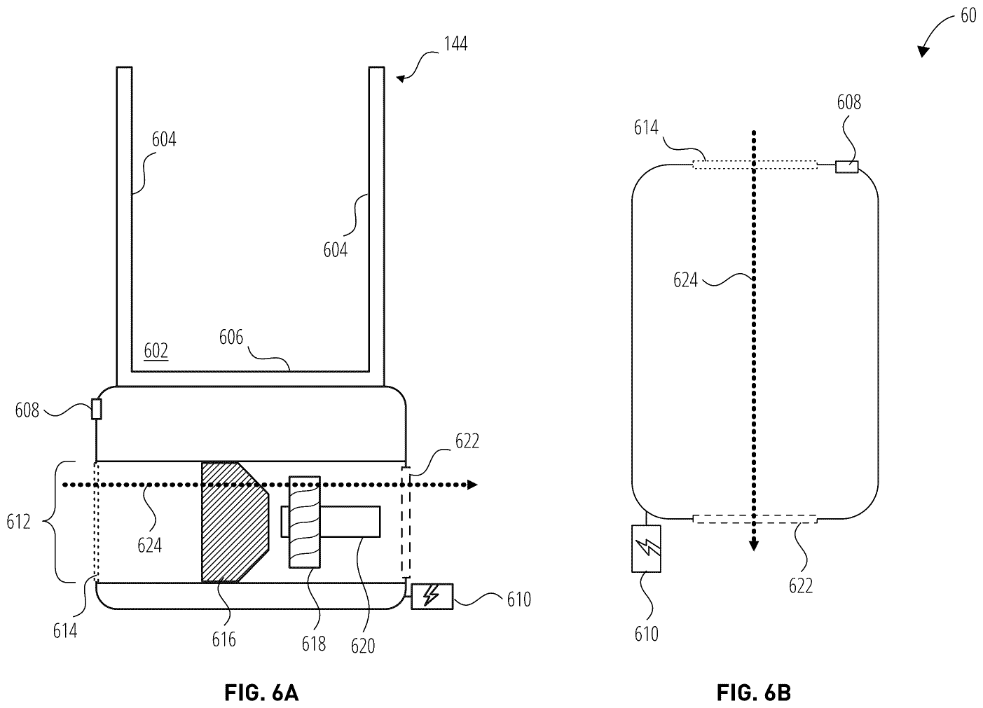

The sanitizing station 100 may include the same vacuum emptying and power charging components described in greater detail with respect to the base station 600 illustrated in FIG. 6A and FIG. 6B. These may include the base station charge connector 608, power source connection 610, and the vacuum emptying system 612. The vacuum emptying system 612 may include a vacuum emptying system intake port 614, a vacuum emptying system fan 618, and a vacuum emptying system motor 620, and a vacuum emptying system exhaust port 622. In one embodiment, the vacuum emptying system 612 may include the vacuum emptying system filter bag 616 as shown in FIG. 6A. In another embodiment, the vacuum emptying system 612 may include a vacuum emptying system filter 136 and a vacuum emptying system dirt collecting bag 138 such as were introduced with respect to FIG. 1A.

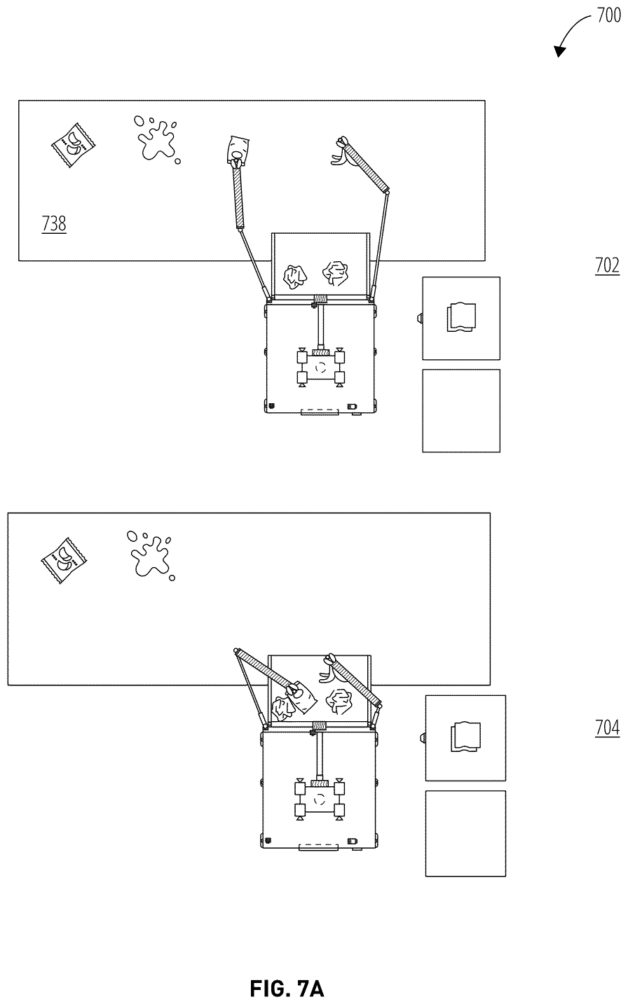

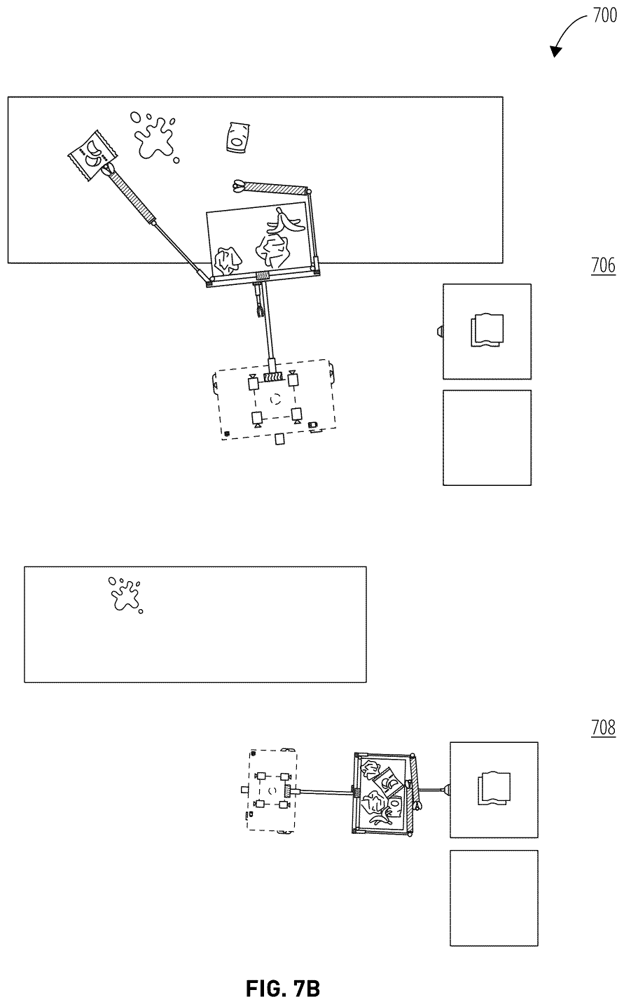

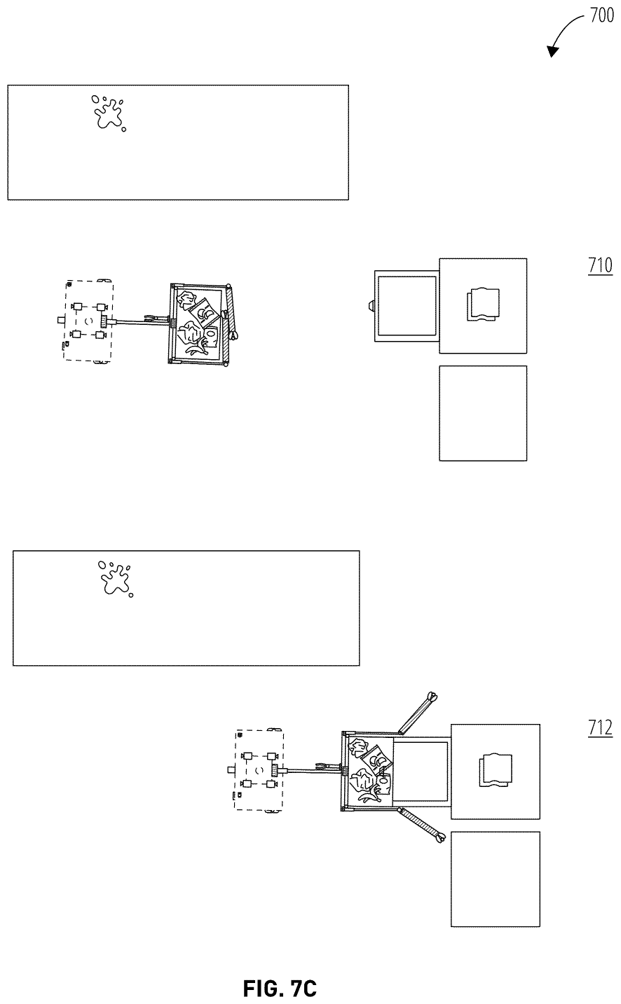

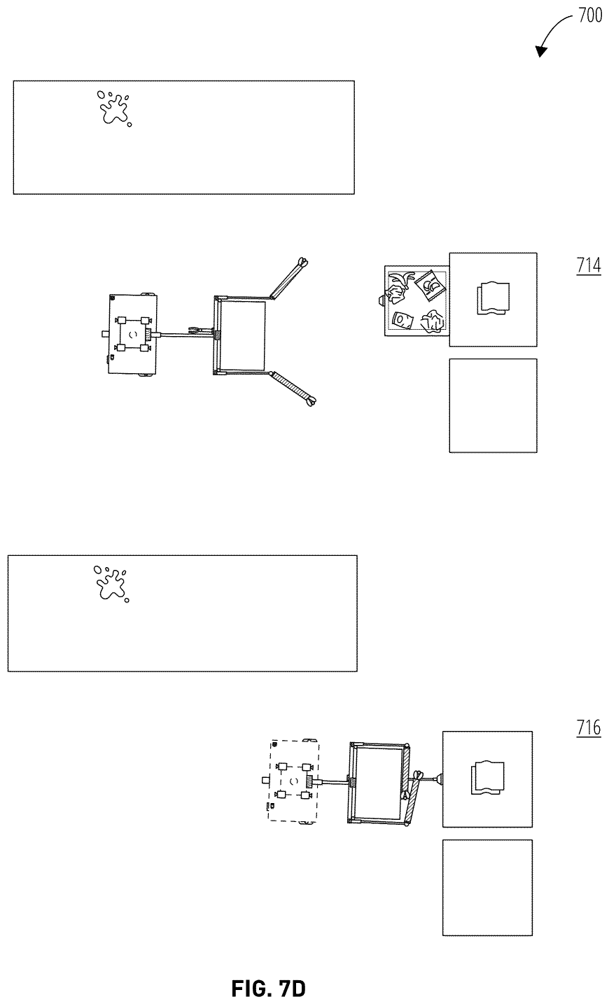

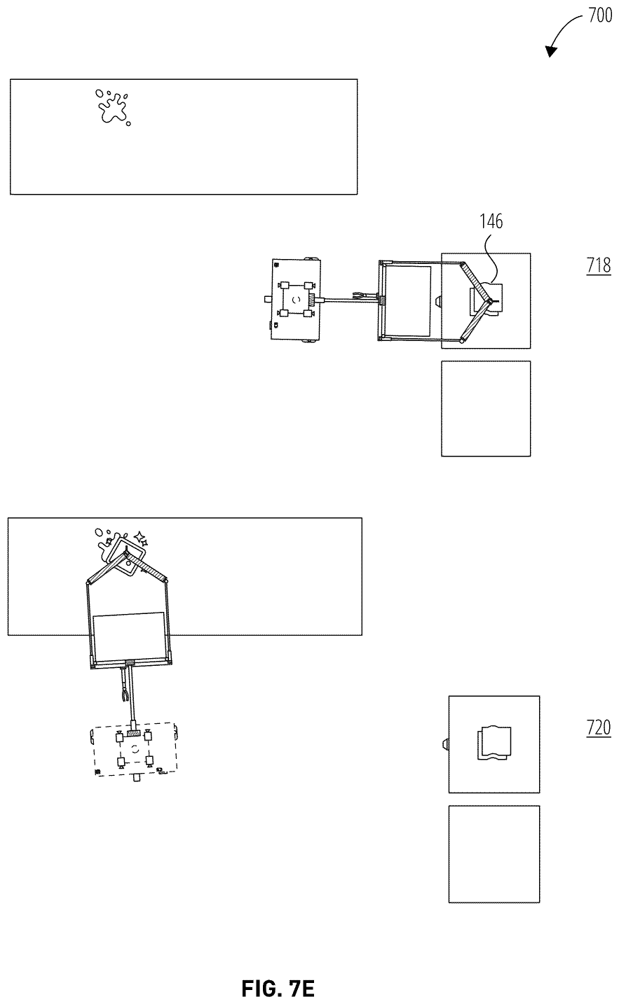

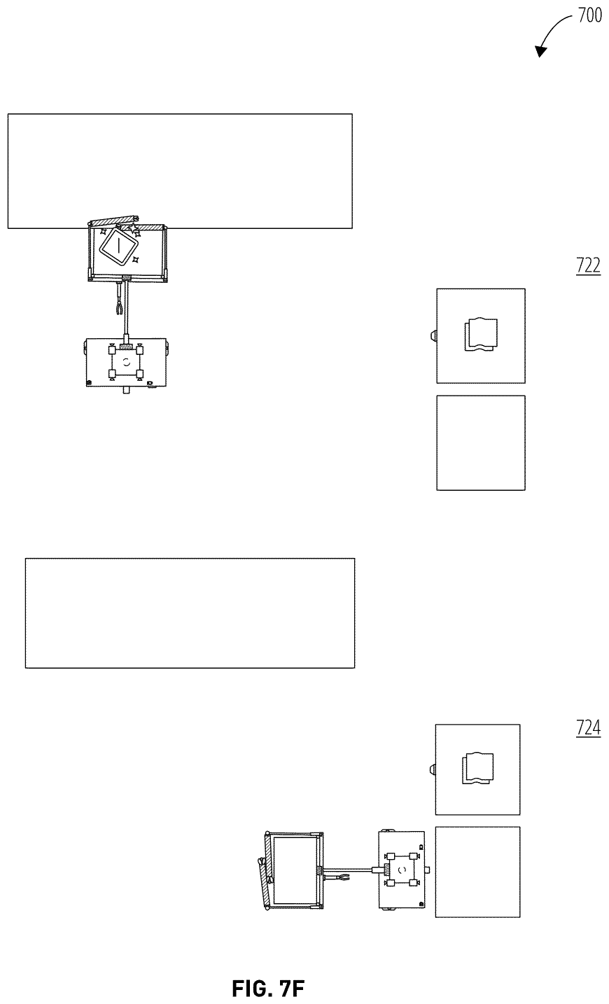

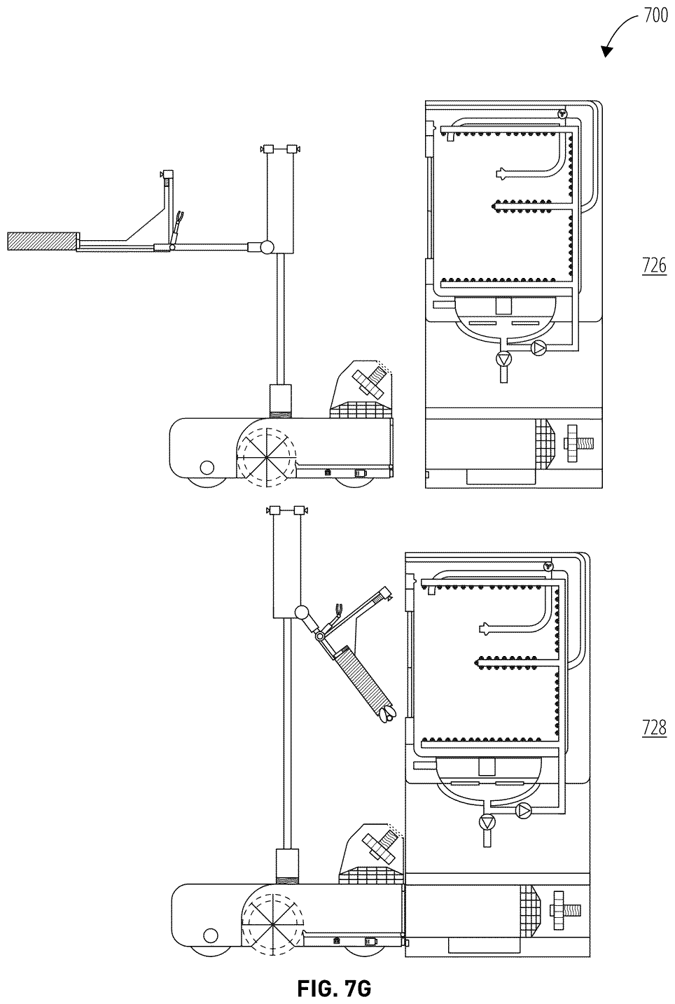

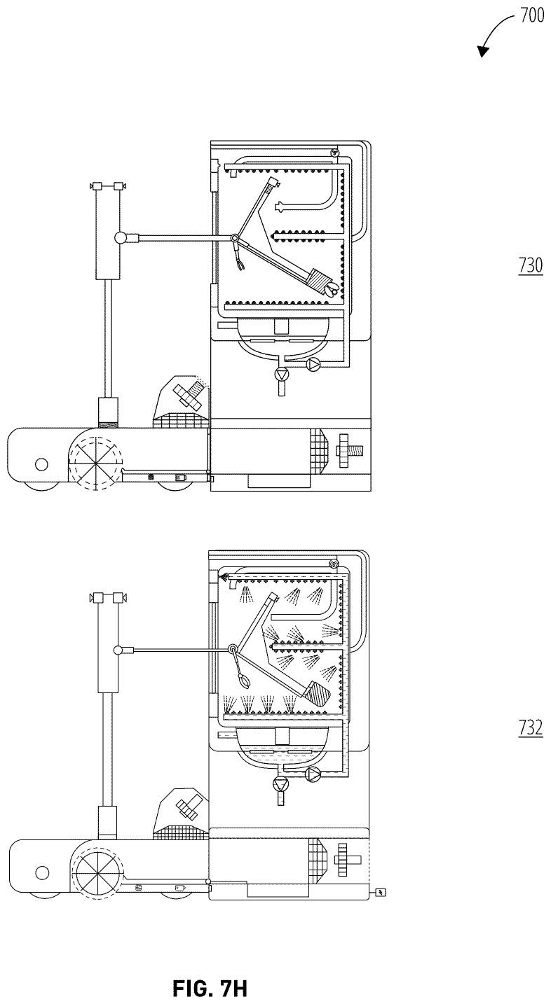

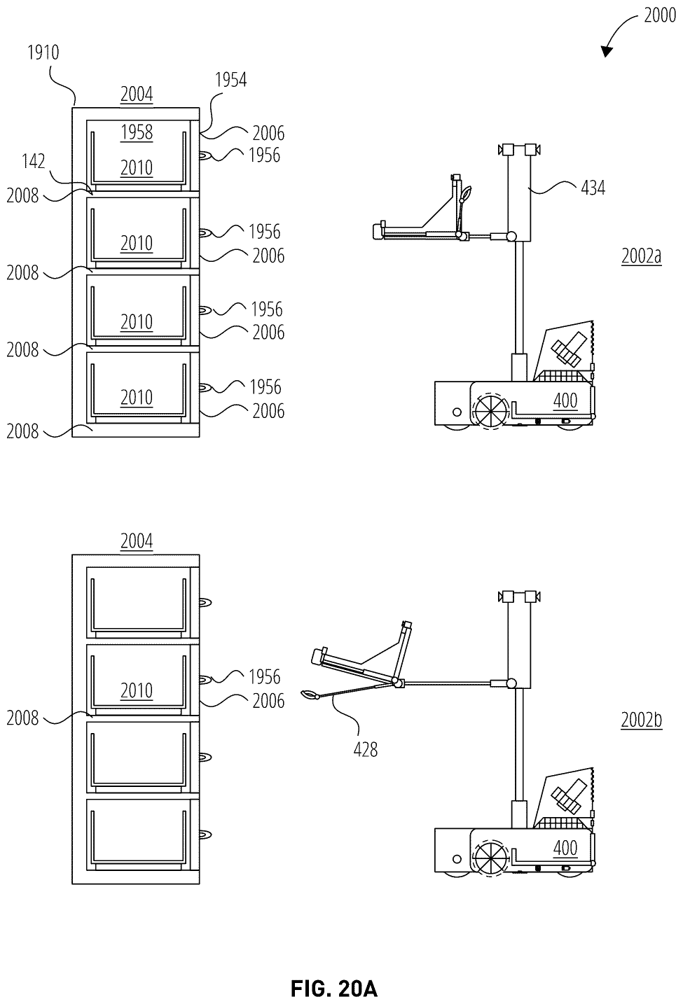

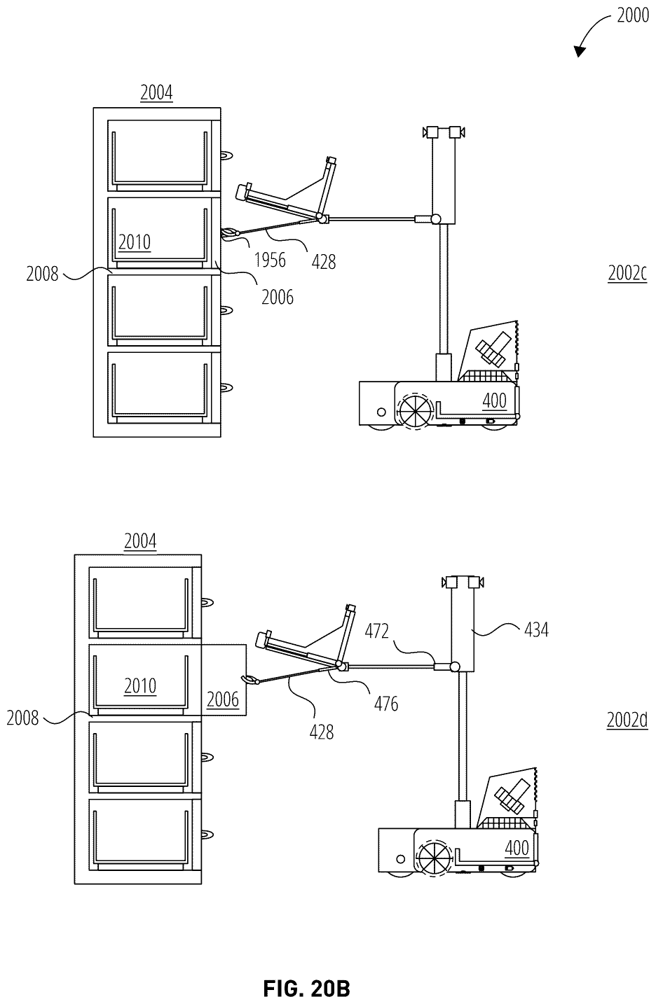

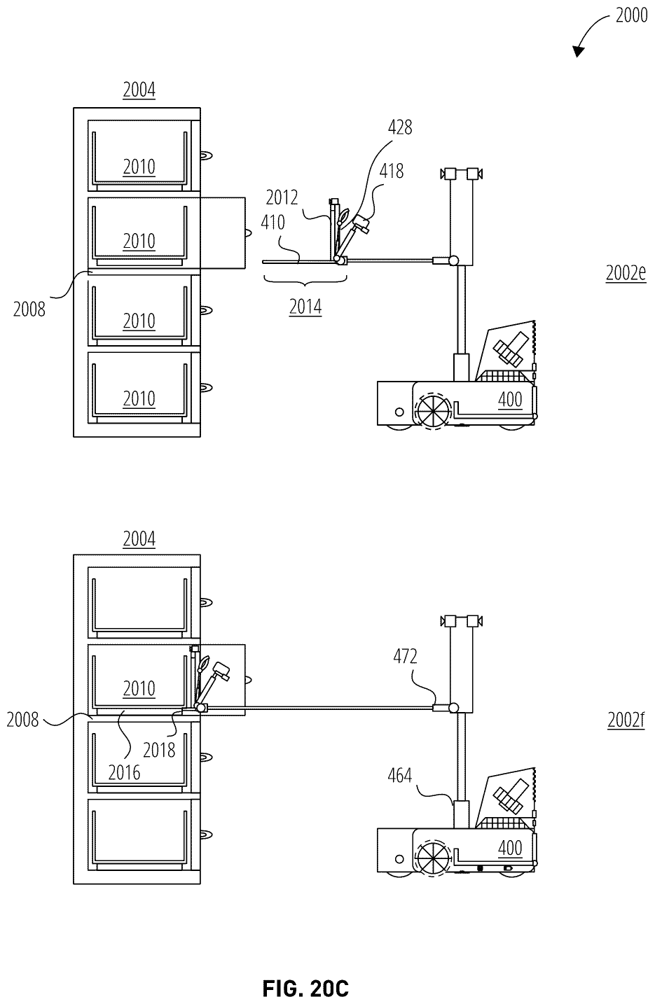

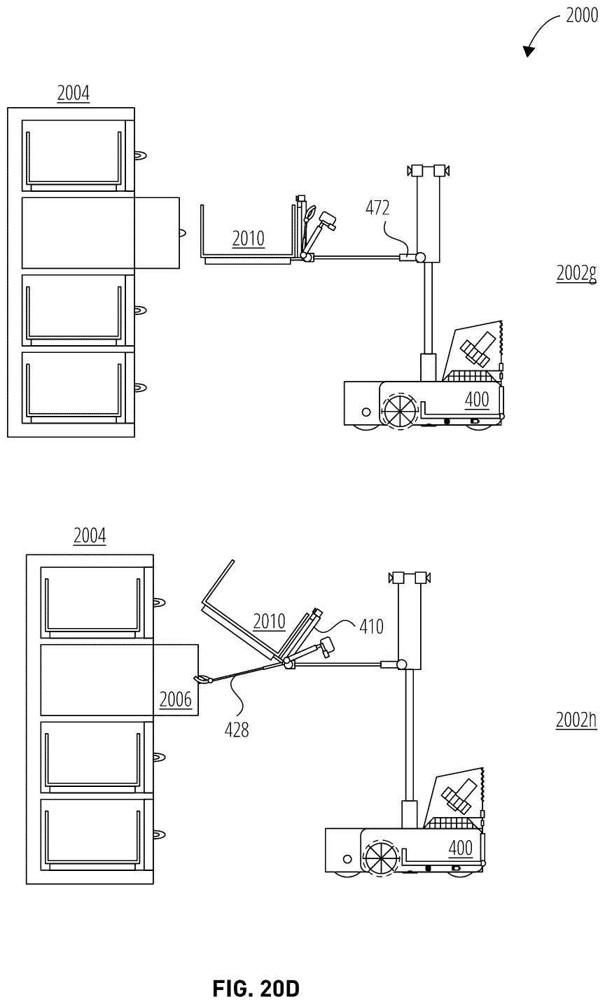

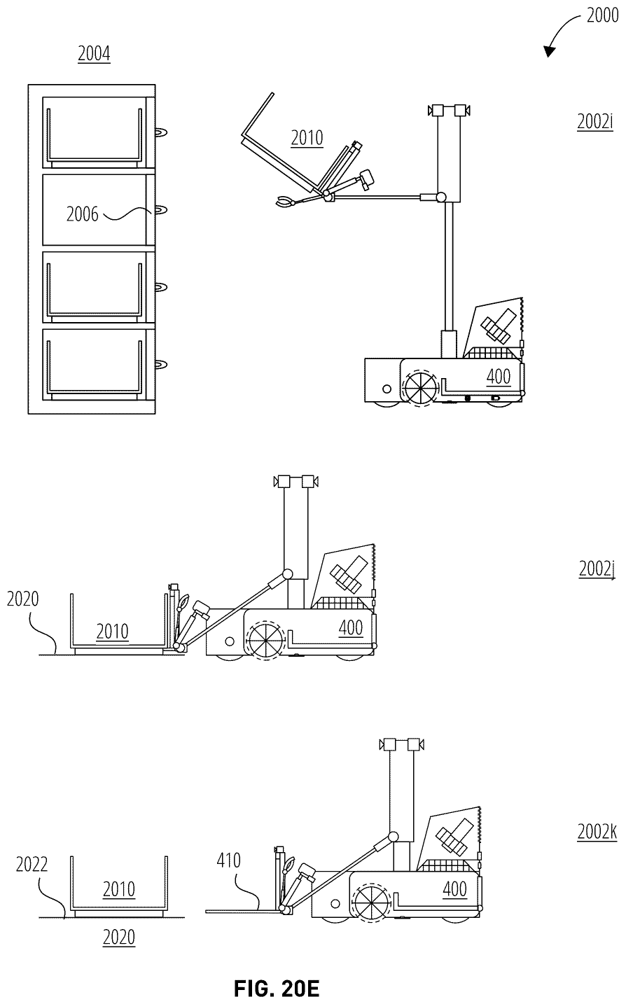

The sanitizing station 100 may include a bin storage 140 cabinet where wipe pads 146 may also be stored. In one embodiment, the wipe pads 146 may incorporate wipe pad tabs 148 that make them easier for the pad end grippers or the ends of the pusher pads to engage with. The bin storage 140 may include storage platforms 142 that may slide in and out of bin storage 140 for ease of access when manipulated by the tidying robot 400, as shown in and described with respect to FIG. 20A-FIG. 20E. Object collection bins 144 may rest on the storage platforms 142, and may be used to segregate different waste products, such as garbage and different types of recyclables, as shown. The sanitizing station 100 may be configured to interact with a tidying robot 400 as it performs the countertop cleaning and sanitizing station use process 700 illustrated in FIG. 7A-FIG. 7I.

In some embodiments, the object collection bins may contain end-effectors or manipulators that are used at the end of the pusher arms of the tidying robot. In some embodiments, these end effectors may be detached from the pusher arms. In further embodiments, the object collection bin containing a desired end effector may also provide a location for the recently detached end effector, thereby providing a location at the sanitizing station 100 for changing/swapping end-effectors. In some embodiments, there may be a different task-specific end effectors such as different types of grippers (e.g., a fabric specific gripper VS a general purpose gripper), cleaning (e.g., a vibrating cleaning pad), suction cups (for lifting flat objects), a spot vacuum or duster to get dirt/dust in corners, a magnetic gripper, or a sprayer attachment for rinsing surfaces, but the end effectors are not limited thereto.

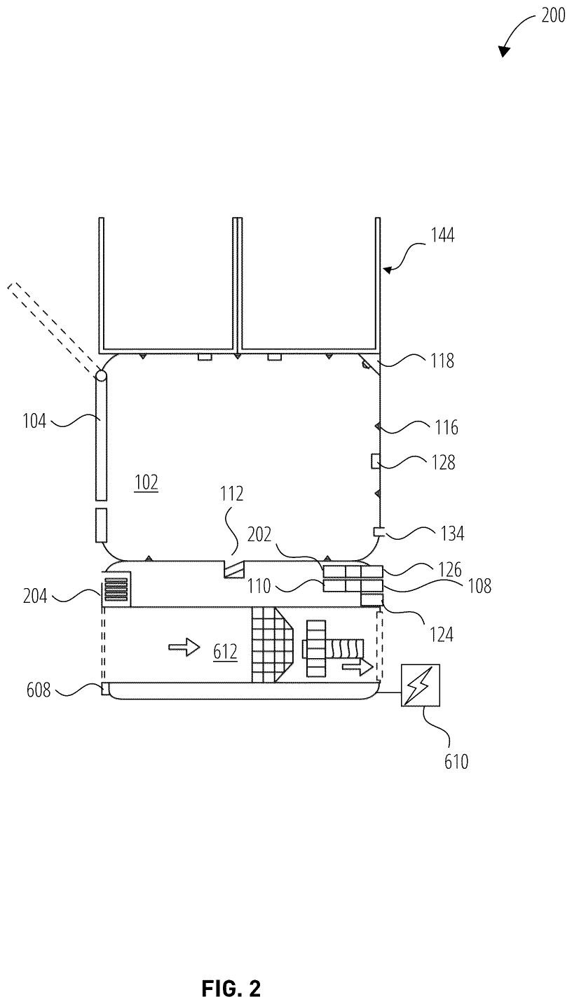

FIG. 2 illustrates a side elevation view of a sanitizing station 200 in accordance with one embodiment. The sanitizing station 200 may also include mop pad storage 204 for the mop pads 436 that may attach to the underside of the tidying robot 400, as described in greater detail below. Rather than bin storage 140 residing alongside the sanitizing chamber 102 portion of the sanitizing station 200, object collection bins 144 may be positioned on top of the sanitizing chamber 102. In other respects, the sanitizing station 200 may include similar features to and operate in a similar manner to the sanitizing station 100 previously described. The sanitizing station 200 may be configured to interact with a tidying robot 400 as it performs the countertop cleaning and sanitizing station use process 700 illustrated in FIG. 7A-FIG. 7I.

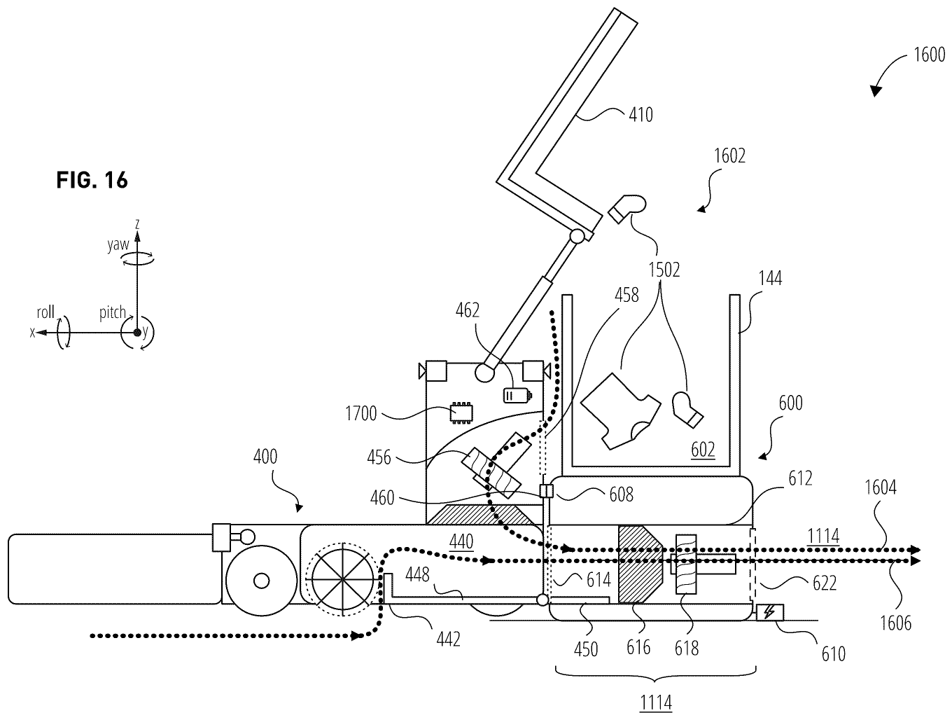

FIG. 3A and FIG. 3B illustrate a side elevation view of a tidying robot interacting with a sanitizing station 300 in accordance with one embodiment. FIG. 3A shows a side elevation view and FIG. 3B shows a top plan view. The tidying robot interacting with a sanitizing station 300 may include interaction with vacuum emptying system 612 and base station charge connector 608 as shown here and as shown and described in more detail with respect to FIG. 16. Where the vacuum emptying system 612 includes the vacuum emptying system filter 136 and vacuum emptying system dirt collecting bag 138, the vacuum emptying system filter 136 may be disposed to filter the vacuum emptying airflow 624 from the vacuum emptying system intake port 614 to the vacuum emptying system exhaust port 622, and a vacuum emptying system dirt collecting bag 138 may be disposed beneath the intake of the vacuum emptying system filter 136 to catch dirt filtered from the vacuum emptying airflow 624.

The water-tight door 104 of the sanitizing station 100 may allow ingress and egress of end effectors 302 of a tidying robot 400. As part of the tidying robot interacting with a sanitizing station 300, the tidying robot 400 may place the end effectors 302 at the end of its scoop arm 414, such as its scoop 410, pusher pads 418, pusher pad arms 420, and gripper arm 428, into the sanitizing chamber 102 as shown. The water-tight door 104 may close around or to either side of the scoop arm 414, and may include rubber sealing flaps or other sealing elements as are well understood in the art, to form a water-tight seal against the scoop arm 414 and prevent sanitizing fluids from leaking out of the sanitizing chamber 102. The water-tight door 104 shown here closes upon the scoop arm 414 from above and below by sliding similarly sized door portions vertically within tracks, but this is not intended to limit such a configuration. One may readily apprehend that such a door may also be rotated to open and close using motors at the upper and lower connection points to sanitizing chamber 102 shown here, may connect to the sides of the sanitizing chamber 102 instead and may slide or rotate to open and close horizontally, may include a large and a small door portion, etc., as best suits the intended application.

With the end effectors 302 of the tidying robot within the sanitizing chamber 102 and the water-tight door 104 closed, The water reservoir 106 may be filled with water from the water intake 108. This water intake 108 may be connected by hose or pipe to a household water supply as will be readily understood by one of ordinary skill in the art. A water heater 110 may heat the water in the water reservoir 106 to a high temperature, such as at or near boiling. The drain 112 of the water reservoir 106 may direct this hot water to a recirculation pump 114 in fluid connection with the water spray nozzles 116 within the sanitizing chamber 102. This hot water 304 may be sprayed on the end effectors 302 of the tidying robot 400, along with detergent 306 from the detergent dispenser 118, thus sanitizing the end effectors 302. The water spray nozzles 116 may spray additional hot water 304 to thoroughly rinse all detergent 306 from the end effectors 302.

After the end effector 302 has been sanitized and rinsed, the hot water 304 and detergent 306 may flow through a wastewater filter 120 back into the water reservoir 106, and may be directed by a wastewater pump 122 from the drain 112 to the wastewater outlet 124. The wastewater outlet 124 may connect through piping or tubing to a household wastewater system as will be readily understood by one of ordinary skill in the art.

Air from the drying air intake 126 may then be pulled by one or more drying fans 128 into drying air conduits 130 that direct this drying airflow onto the end effectors 302. The drying airflow 308 may pass through an air outlet conduit 132 to a drying air outlet 134. In one embodiment, the drying airflow 308 may be heated by an air heater 202 before passing into the drying air conduit 130 to speed the drying process. Once the end effectors 302 are dry, the water-tight door 104 may be opened and the end effectors 302 may be removed from the sanitizing chamber 102.

Referring to FIG. 3A and FIG. 3B, it will be readily apparent to one of ordinary skill in the art that the dimensions of the elements illustrated for the sanitizing station 100 (as well as those of the sanitizing station 200) may be selected to accommodate the design of the tidying robot 400. The sanitizing chamber 102 in particular may be taller, wider, or deeper than illustrated herein to accommodate larger end effector 302 configurations.

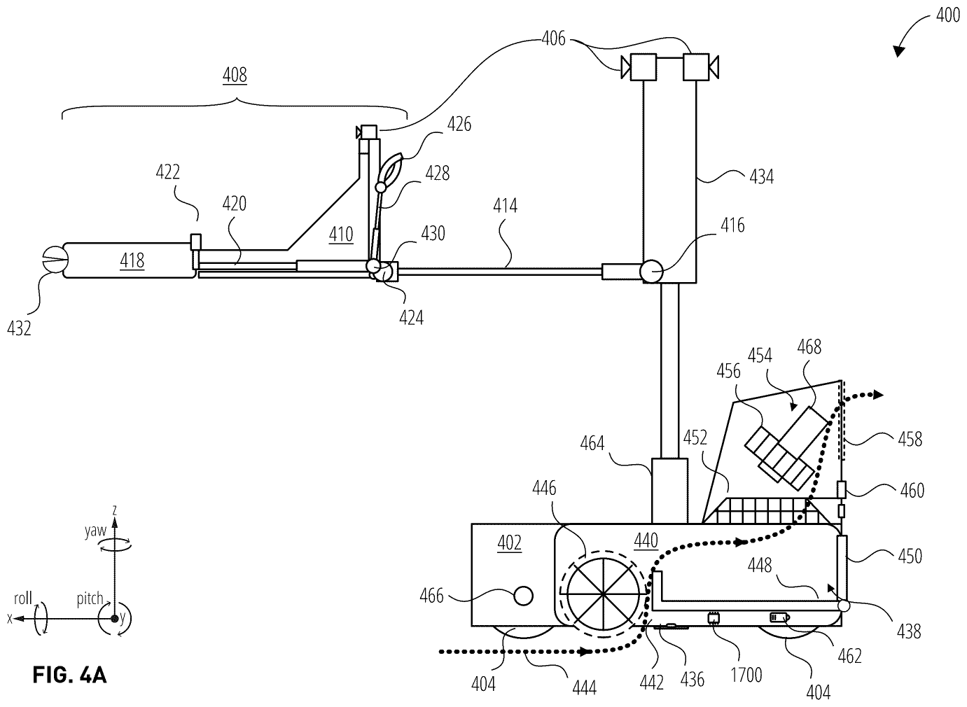

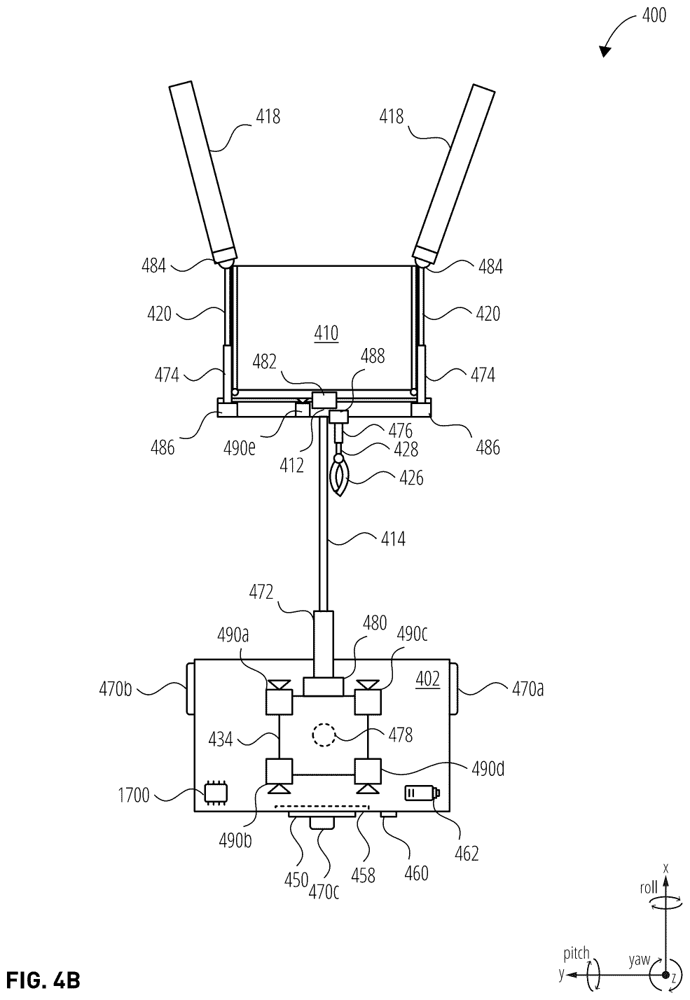

FIG. 4A-FIG. 4B illustrate a tidying robot 400 in accordance with one embodiment. FIG. 4A shows a side view and FIG. 4B shows a top view. The tidying robot 400 may comprise a chassis 402, a mobility system 404, a sensing system 406, a capture and containment system 408, and a robotic control system 1700. The capture and containment system 408 may further comprise a scoop 410, a scoop pivot point 412, a scoop arm 414, a scoop arm pivot point 416, two pusher pads 418 with pad pivot points 422, two pusher pad arms 420 with pad arm pivot points 424, an actuated gripper 426, a gripper arm 428 with a gripper pivot point 430, a pad end gripper 432 at the end of each pusher pad 418, and a lifting column 434 to raise and lower the capture and containment system 408 to a desired height. In one embodiment, the gripper arm 428 may include features for gripping and/or gripping surfaces in lieu of or in addition to an actuated gripper 426.

The tidying robot 400 may further include a mop pad 436, and robot vacuum system 438. The robot vacuum system 438 may include a vacuum compartment 440, a vacuum compartment intake port 442, a cleaning airflow 444, a rotating brush 446, a dirt collector 448, a dirt release latch 450, a vacuum compartment filter 452, and a vacuum generating assembly 454 that includes a vacuum compartment fan 456, a vacuum compartment motor 468, and a vacuum compartment exhaust port 458. The tidying robot 400 may include a robot charge connector 460, a battery 462, and number of motors, actuators, sensors, and mobility components as described in greater detail below, and a robotic control system 1700 providing actuation signals based on sensor signals and user inputs.

The chassis 402 may support and contain the other components of the tidying robot 400. The mobility system 404 may comprise wheels as indicated, as well as caterpillar tracks, conveyor belts, etc., as is well understood in the art. The mobility system 404 may further comprise motors, servos, or other sources of rotational or kinetic energy to impel the tidying robot 400 along its desired paths. Mobility system 404 components may be mounted on the chassis 402 for the purpose of moving the entire robot without impeding or inhibiting the range of motion needed by the capture and containment system 408. Elements of a sensing system 406, such as cameras, lidar sensors, or other components, may be mounted on the chassis 402 in positions giving the tidying robot 400 clear lines of sight around its environment in at least some configurations of the chassis 402, scoop 410, pusher pad 418, and pusher pad arm 420 with respect to each other.

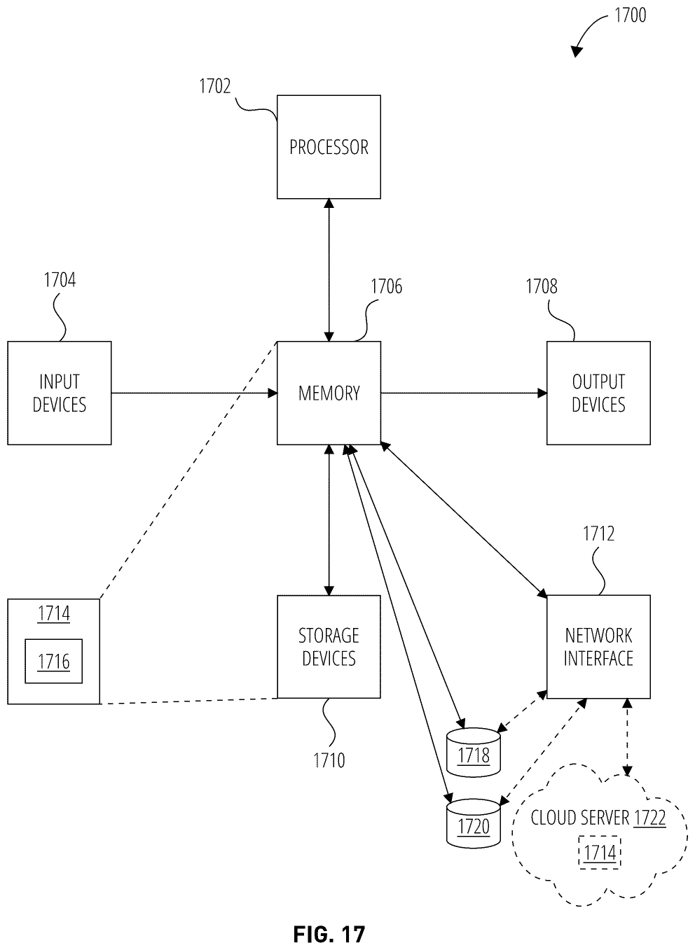

The chassis 402 may house and protect all or portions of the robotic control system 1700, (portions of which may also be accessed via connection to a cloud server) comprising in some embodiments a processor, memory, and connections to the mobility system 404, sensing system 406, and capture and containment system 408. The chassis 402 may contain other electronic components such as batteries 462, wireless communications 506 devices, etc., as is well understood in the art of robotics. The robotic control system 1700 may function as described in greater detail with respect to FIG. 17. The mobility system 404 and or the robotic control system 1700 may incorporate motor controllers used to control the speed, direction, position, and smooth movement of the motors. Such controllers may also be used to detect force feedback and limit maximum current (provide overcurrent protection) to ensure safety and prevent damage.

The capture and containment system 408 may comprise a scoop 410 with an associated scoop motor 482 to rotate the scoop 410 into different positions at the scoop pivot point 412. The capture and containment system 408 may also include a scoop arm 414 with an associated scoop arm motor 480 to rotate the scoop arm 414 into different positions around the scoop arm pivot point 416, and a scoop arm linear actuator 472 to extend the scoop arm 414. Pusher pads 418 of the capture and containment system 408 may have pusher pad motors 484 to rotate them into different positions around the pad pivot points 422. Pusher pad arms 420 may be associated with pusher pad arm motors 486 that rotate them around pad arm pivot points 424, as well as pusher pad arm linear actuators 474 to extend and retract the pusher pad arms 420. The gripper arm 428 may include a gripper arm motor 488 to move the gripper arm 428 around a gripper pivot point 430, as well as a gripper arm linear actuator 476 to extend and retract the gripper arm 428. In this manner the gripper arm 428 may be able to move and position itself and/or the actuated gripper 426 to perform the tasks disclosed herein.

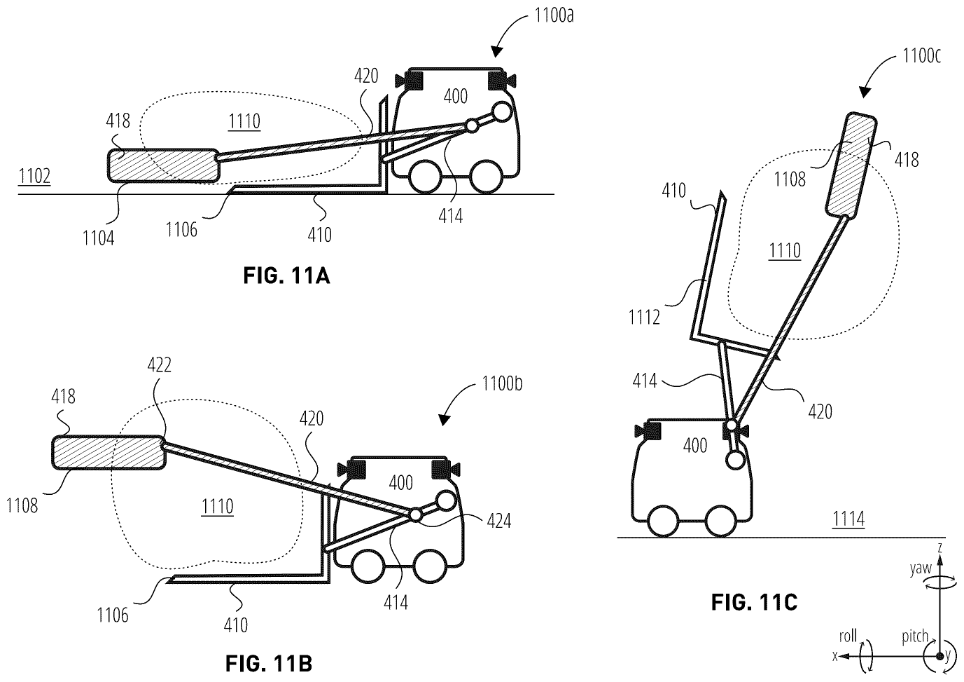

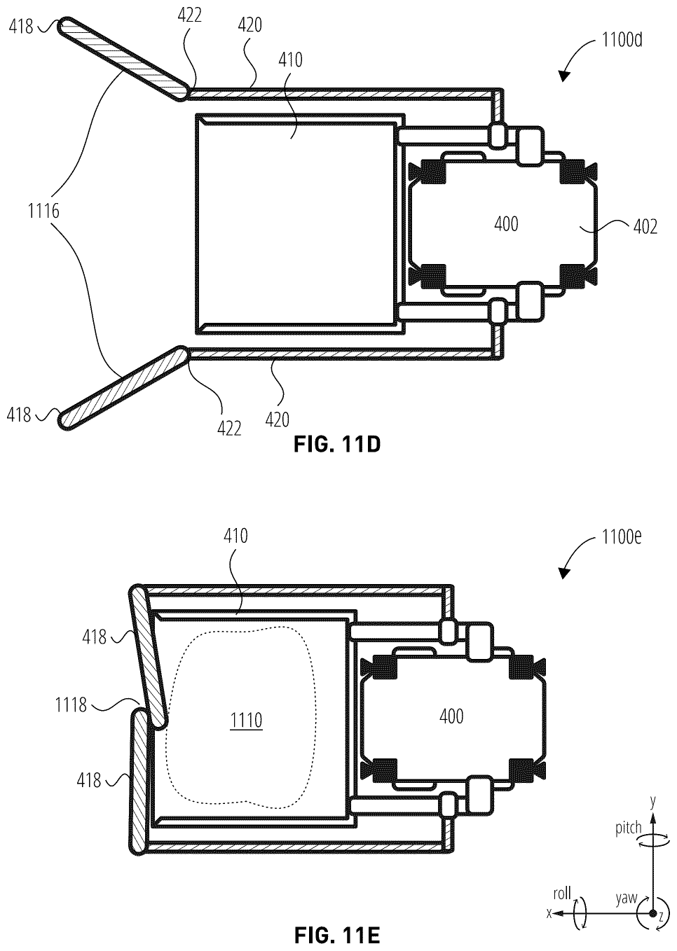

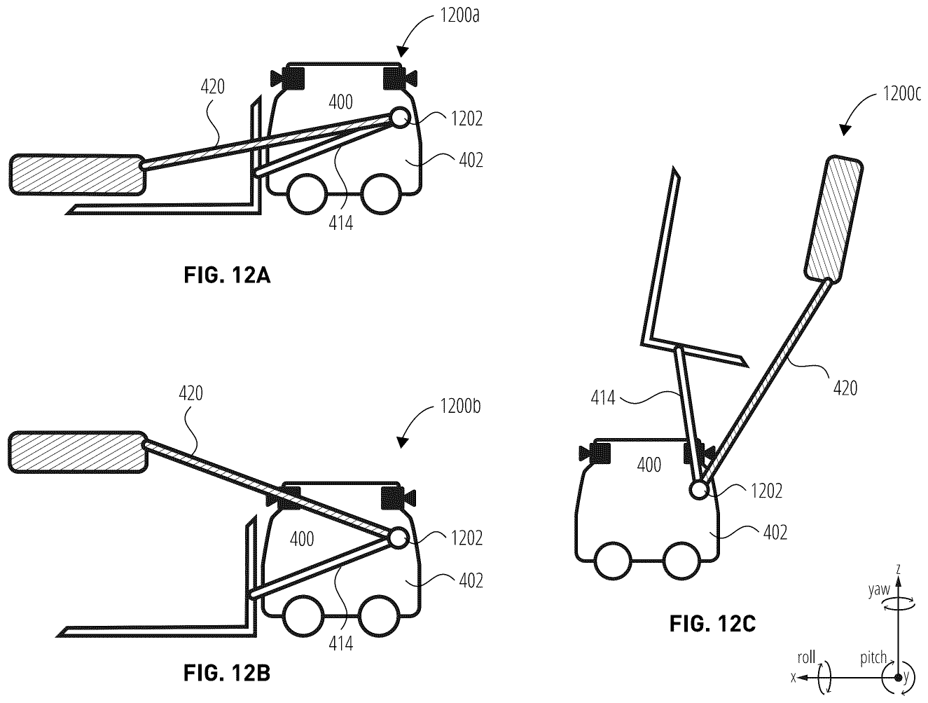

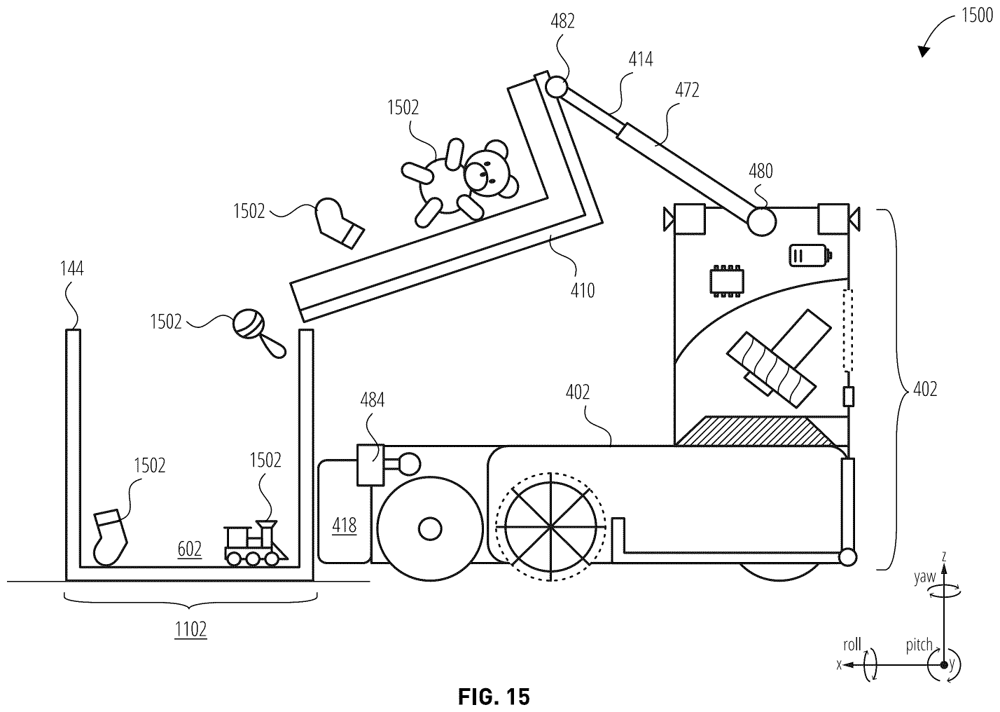

Points of connection shown herein between the scoop arms and pusher pad arms are exemplary positions and are not intended to limit the physical location of such points of connection. Such connections may be made in various locations as appropriate to the construction of the chassis and arms, and the applications of intended use. In some embodiments, the pusher pad arms 420 may attach to the scoop 410, as shown here. In other embodiments, the pusher pad arm 420 may attach to the chassis 402 as shown, for example, in FIG. 12A or FIG. 15. It will be well understood by one of ordinary skill in the art that the configurations illustrated may be designed to perform the basic motions described with respect to FIG. 11A-FIG. 16 and the processes illustrated elsewhere herein.

The geometry of the scoop 410 and the disposition of the pusher pads 418 and pusher pad arms 420 with respect to the scoop 410 may describe a containment area, illustrated more clearly in FIG. 11A-FIG. 11E, in which objects may be securely carried. Servos, direct current (DC) motors, or other actuators at the scoop arm pivot point 416, pad pivot points 422, and pad arm pivot points 424 may be used to adjust the disposition of the scoop 410, pusher pads 418, and pusher pad arms 420 between fully lowered scoop and grabber positions and raised scoop and grabber positions, as illustrated with respect to FIG. 11A-FIG. 11C.

In some embodiments, gripping surfaces may be configured on the sides of the pusher pads 418 facing inward toward objects to be lifted. These gripping surfaces may provide cushion, grit, elasticity, or some other feature that increases friction between the pusher pads 418 and objects to be captured and contained. In some embodiments, the pusher pad 418 may include suction cups in order to better grasp objects having smooth, flat surfaces. In some embodiments, the pusher pads 418 may be configured with sweeping bristles. These sweeping bristles may assist in moving small objects from the floor up onto the scoop 410. In some embodiments, the sweeping bristles may angle down and inward from the pusher pads 418, such that, when the pusher pads 418 sweep objects toward the scoop 410, the sweeping bristles form a ramp, allowing the foremost bristles to slide beneath the object, and direct the object upward toward the pusher pads 418, facilitating capture of the object within the scoop and reducing a tendency of the object to be pressed against the floor, increasing its friction and making it more difficult to move.

The capture and containment system 408, as well as some portions of the sensing system 406, may be mounted atop a lifting column 434, such that these components may be raised and lowered with respect to the ground to facilitate performance of complex tasks. A lifting column linear actuator 464 may control the elevation of the capture and containment system 408 by extending and retracting the lifting column 434. A lifting column motor 478 may allow the lifting column 434 to rotate so that the capture and containment system 408 may be moved with respect to the tidying robot 400 base or chassis 402 in all three dimensions.

The tidying robot 400 may include floor cleaning components such as a mop pad 436 and a vacuuming system. The mop pad 436 may be able to raise and lower with respect to the bottom of the tidying robot 400 chassis 402, so that it may be placed in contact with the floor when desired. The mop pad 436 may include a drying element to dry wet spots detected on the floor. In one embodiment, the tidying robot 400 may include a fluid reservoir, which may be in contact with the mop pad 436 and able to dampen the mop pad 436 for cleaning. In one embodiment, the tidying robot 400 may be able to spray cleaning fluid from a fluid reservoir onto the floor in front of or behind the tidying robot 400, which may then be absorbed by the mop pad 436.

The vacuuming system may include a vacuum compartment 440, which may have a vacuum compartment intake port 442 allowing cleaning airflow 444 into the vacuum compartment 440. The vacuum compartment intake port 442 may be configured with a rotating brush 446 to impel dirt and dust into the vacuum compartment 440. Cleaning airflow 444 may be induced to flow by a vacuum compartment fan 456 powered by a vacuum compartment motor 468. cleaning airflow 444 may pass through the vacuum compartment 440 from the vacuum compartment intake port 442 to a vacuum compartment exhaust port 458, exiting the vacuum compartment 440 at the vacuum compartment exhaust port 458. The vacuum compartment exhaust port 458 may be covered by a grating or other element permeable to cleaning airflow 444 but able to prevent the ingress of objects into the chassis 402 of the tidying robot 400.

A vacuum compartment filter 452 may be disposed between the vacuum compartment intake port 442 and the vacuum compartment exhaust port 458. The vacuum compartment filter 452 may prevent dirt and dust from entering and clogging the vacuum compartment fan 456. The vacuum compartment filter 452 may be disposed such that blocked dirt and dust are deposited within a dirt collector 448. The dirt collector 448 may be closed off from the outside of the chassis 402 by a dirt release latch 450. The dirt release latch 450 may be configured to open when the tidying robot 400 is docked at a base station 600 with a vacuum emptying system 612, as is illustrated in FIG. 6A and FIG. 6B and described below. A robot charge connector 460 may connect the tidying robot 400 to a base station charge connector 608, allowing power from the base station 600 to charge the tidying robot 400 battery 462.

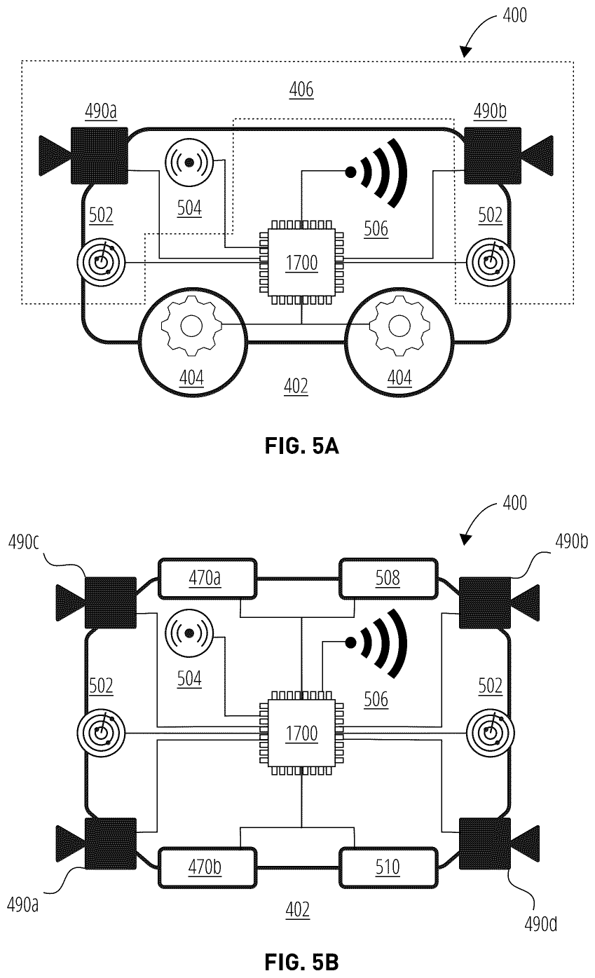

FIG. 5A and FIG. 5B illustrate a simplified side view and top view of a chassis 402, respectively, in order to show in more detail aspects of the mobility system 404, the sensing system 406, and the communications 506, in connection with the robotic control system 1700. In some embodiments, the communications 506 may include the network interface 1712 described in greater detail with respect to robotic control system 1700.

In one embodiment, the mobility system 404 may comprise a left front wheel 470b and a right front wheel 470a powered by mobility system motor 466, and a single rear wheel 470c, as illustrated in FIG. 4A and FIG. 4B. The single rear wheel 470c may be actuated or may be a passive roller or caster providing support and reduced friction with no driving force.

In one embodiment, the mobility system 404 may comprise a right front wheel 470a, a left front wheel 470b, a right rear wheel 508, and a left rear wheel 510. The tidying robot 400 may have front-wheel drive, where right front wheel 470a and left front wheel 470b are actively driven by one or more actuators or motors, while the right rear wheel 508 and left rear wheel 510 spin on an axle passively while supporting the rear portion of the chassis 402. In another embodiment, the tidying robot 400 may have rear-wheel drive, where the right rear wheel 508 and left rear wheel 510 are actuated and the front wheels turn passively. In another embodiment, the tidying robot 400 may have additional motors to provide all-wheel drive, may use a different number of wheels, or may use caterpillar tracks or other mobility devices in lieu of wheels.

The sensing system 406 may further comprise cameras such as the front left camera 490a, rear left camera 490b, front right camera 490c, rear right camera 490d, and scoop camera 490e, light detecting and ranging (LIDAR) sensors such as lidar sensors 502, and inertial measurement unit (IMU) sensors, such as IMU sensors 504. In some embodiments, there may be a single front camera and a single rear camera.

FIG. 6A and FIG. 6B illustrate a base station 600 in accordance with one embodiment. FIG. 6A shows a left side view and FIG. 6B shows a top view. The base station 600 may comprise an object collection bin 144 with a storage compartment 602 to hold tidyable objects, heavy dirt and debris, or other obstructions. The storage compartment 602 may be formed by bin sides 604 and a bin base 606. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc. The base station 600 may further comprise a base station charge connector 608, a power source connection 610, and a vacuum emptying system 612 including a vacuum emptying system intake port 614, a vacuum emptying system filter bag 616, a vacuum emptying system fan 618, a vacuum emptying system motor 620, and a vacuum emptying system exhaust port 622.

The object collection bin 144 may be configured on top of the base station 600 so that a tidying robot 400 may deposit objects from the scoop 410 into the object collection bin 144. The base station charge connector 608 may be electrically coupled to the power source connection 610. The power source connection 610 may be a cable connector configured to couple through a cable to an alternating current (AC) or direct current (DC) source, a battery, or a wireless charging port, as will be readily apprehended by one of ordinary skill in the art. In one embodiment, the power source connection 610 is a cable and male connector configured to couple with 120V AC power, such as may be provided by a conventional U.S. home power outlet.

The vacuum emptying system 612 may include a vacuum emptying system intake port 614 allowing vacuum emptying airflow 624 into the vacuum emptying system 612. The vacuum emptying system intake port 614 may be configured with a flap or other component to protect the interior of the vacuum emptying system 612 when a tidying robot 400 is not docked. A vacuum emptying system filter bag 616 may be disposed between the vacuum emptying system intake port 614 and a vacuum emptying system fan 618 to catch dust and dirt carried by the vacuum emptying airflow 624 into the vacuum emptying system 612. The vacuum emptying system fan 618 may be powered by a vacuum emptying system motor 620. The vacuum emptying system fan 618 may pull the vacuum emptying airflow 624 from the vacuum emptying system intake port 614 to the vacuum emptying system exhaust port 622, which may be configured to allow the vacuum emptying airflow 624 to exit the vacuum emptying system 612. The vacuum emptying system exhaust port 622 may be covered with a grid to protect the interior of the vacuum emptying system 612.

FIG. 7A-FIG. 7I illustrate a countertop cleaning and sanitizing station use process 700 in accordance with one embodiment. The countertop cleaning and sanitizing station use process 700 may be performed by a tidying robot such as the tidying robot 400 described in greater detail below with respect to FIG. 4A and FIG. 4B. Such a tidying robot may interface according to the steps of the countertop cleaning and sanitizing station use process 700 with a sanitizing station such as the sanitizing station 100 or sanitizing station 200 introduced above.

In step 702 the tidying robot 400 may use pad end grippers to grip individual items on a countertop 738, such as the wrapper and banana peels shown. The tidying robot may then adjust the position of its pusher pads to place these items in its scoop, as shown in step 704. In step 706, the robot may use its pusher pads to encapsulate and sweep another item of trash into its scoop. The pad end grippers and pusher pads may be used in a similar manner repeatedly until the countertop is clean or the scoop is full.

In step 708, the robot may use its gripper arm to open or otherwise make accessible a storage bin, such as a garbage bin stored in bin storage. In step 710, the storage bin may be opened and the robot may position itself to dock with the storage bin. In step 712, the robot positions the scoop ready to dump into the open storage bin. In step 714, the robot has dumped all the garbage into the bin. In step 716, the robot may use its gripper arm to close the bin or push it back into its compartment in the bin storage.

In step 718, the robot uses pad end grippers to pick up a wipe pad 146 for cleaning. In step 720, the robot uses the wipe pad to wipe the countertop, absorbing spills and in one embodiment applying cleaning solution to the countertop. In step 722, the robot pushes the cleaning wipe and any crumbs into the scoop. The tidying robot 400 may repeat steps above to dispose of the wipe pad in a storage bin within bin storage.

In step 724, the countertop is now clean and the robot approaches the sanitization station. In step 726, the robot backs toward the sanitizing station. In step 728, the robot holds its end effectors facing the sanitization station, and robot backs up to dock with sanitization. In one embodiment, the end effectors may include portions of the capture and containment system 408 of the tidying robot 400 illustrated in FIG. 4A and FIG. 4B. Doors open for the sanitization station. In step 730, the end effectors are positioned into the sanitization station and the door close sealing end effector inside. In step 732, Sanitization station goes through operation cycles with pre-rinse, sanitation, first rinse, second rinse, and drying cycle, or similar cycle patterns as will be readily understood by one of ordinary skill in the art. In step 734, the sanitizing station water-tight door opens and the now clean end effectors are removed from the sanitization station. In step 736, the robot drives away to begin its next activity and the sanitization station doors close.

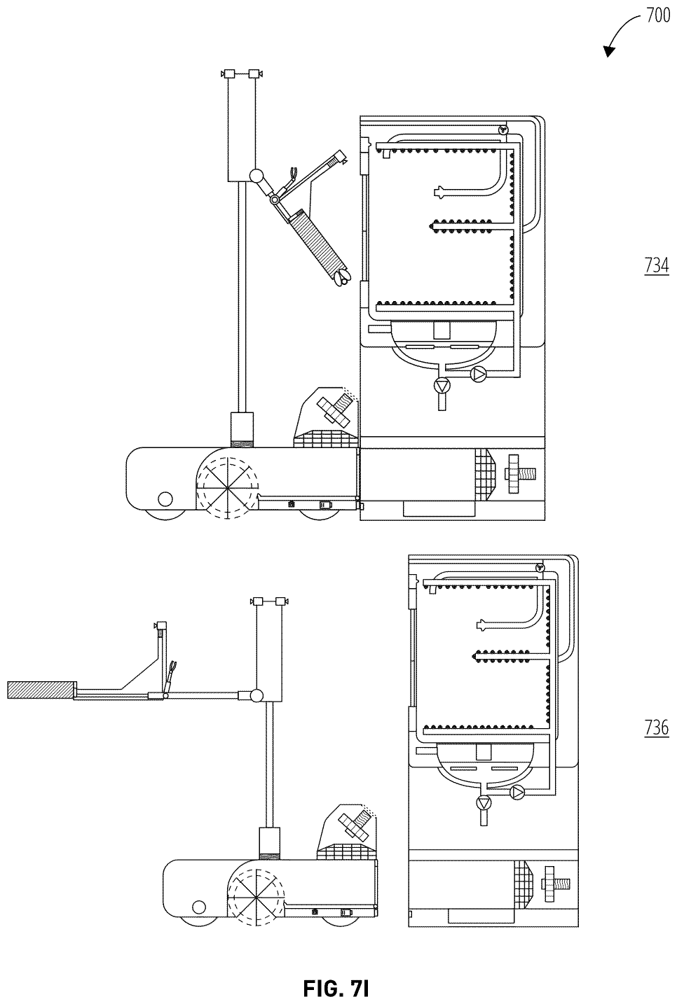

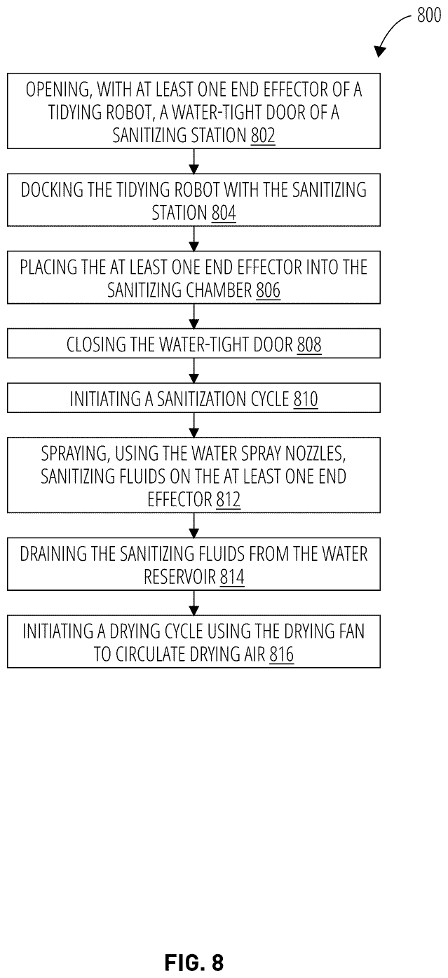

FIG. 8 illustrates an example method 800 for sanitizing the end effectors of a tidying robot. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

According to some embodiments, the method includes opening, with at least one end effector of a tidying robot, a water-tight door of a sanitizing station at block 802. The sanitizing station is disclosed in FIG. 1A to FIG. 3B. The method includes docking the tidying robot with the sanitizing station at block 804, placing the at least one end effector into the sanitizing chamber at block 806, and closing the water-tight door at block 808.

According to some embodiments, the method includes initiating a sanitization cycle at block 810, including spraying, using the water spray nozzles, sanitizing fluids on the at least one end effector at block 812, followed by draining the sanitizing fluids from the water reservoir at block 814.

According to some embodiments, the method further includes initiating a drying cycle using the drying fan to circulate drying air at block 816.

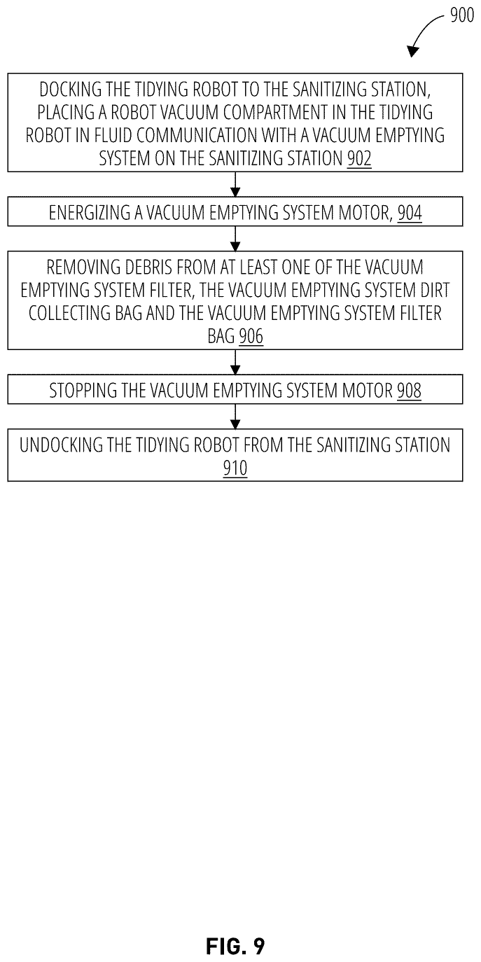

FIG. 9 illustrates an example method 900 for emptying a tidying robot vacuum system.

According to some embodiments, the method includes docking the tidying robot to the sanitizing station, placing a robot vacuum compartment in the tidying robot in fluid communication with a vacuum emptying system on the sanitizing station at block 902, energizing a vacuum emptying system motor, at block 904, removing debris from at least one of the vacuum emptying system filter, the vacuum emptying system dirt collecting bag and the vacuum emptying system filter bag at block 906 and stopping the vacuum emptying system motor at block 908.

According to some embodiments, the method further includes undocking the tidying robot from the sanitizing station at block 910.

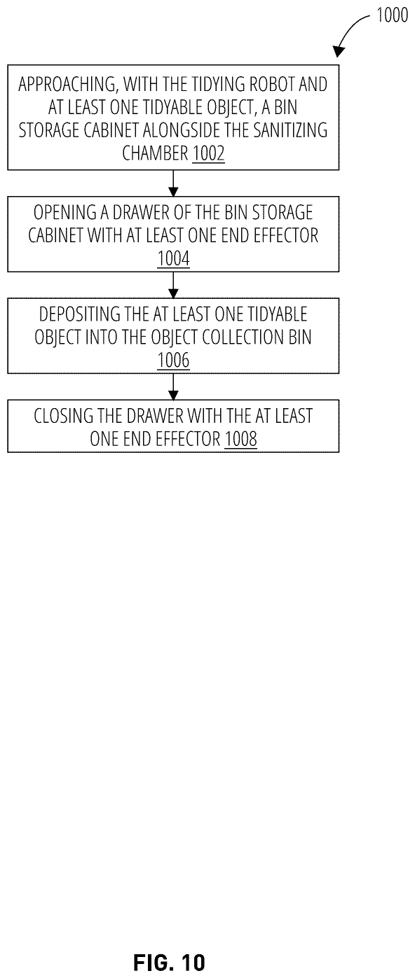

FIG. 10 illustrates an example method 1000 for depositing tidyable objects into an object collection bin in a storage bin. According to some embodiments, the method includes approaching, with the tidying robot and at least one tidyable object, the bin storage cabinet alongside the sanitizing chamber at block 1002, opening a drawer of the bin storage cabinet with at least one end effector at block 1004, depositing the at least one tidyable object into the object collection bin at block 1006.

According to some embodiments, the method further includes closing the drawer with the at least one end effector at block 1008.

In some embodiments, the method may further include removing the at least one end effector and placing the removed at least one end effector into the object collection bin, wherein the object collection bin contains at least one different end effector. These steps are followed by placing the at least one different end effector on the tidying robot. In some embodiments, using this method allows the tidying robot to sanitize an end effector and place it into an object collection bin before applying a different end effector to the tidying robot.

FIG. 11A illustrates a tidying robot 400 such as that introduced with respect to FIG. 4A disposed in a lowered scoop position and lowered pusher position 1100a. In this configuration, the pusher pads 418 and pusher pad arms 420 rest in a lowered pusher position 1104, and the scoop 410 and scoop arm 414 rest in a lowered scoop position 1106 at the front 1102 of the tidying robot 400. In this position, the scoop 410 and pusher pads 418 may roughly describe a containment area 1110 as shown.

FIG. 11B illustrates a tidying robot 400 with a lowered scoop position and raised pusher position 1100b. Through the action of servos or other actuators at the pad pivot points 422 and pad arm pivot points 424, the pusher pads 418 and pusher pad arms 420 may be raised to a raised pusher position 1108 while the scoop 410 and scoop arm 414 maintain a lowered scoop position 1106. In this configuration, the pusher pads 418 and scoop 410 may roughly describe a containment area 1110 as shown, in which an object taller than the scoop 410 height may rest within the scoop 410 and be held in place through pressure exerted by the pusher pads 418.

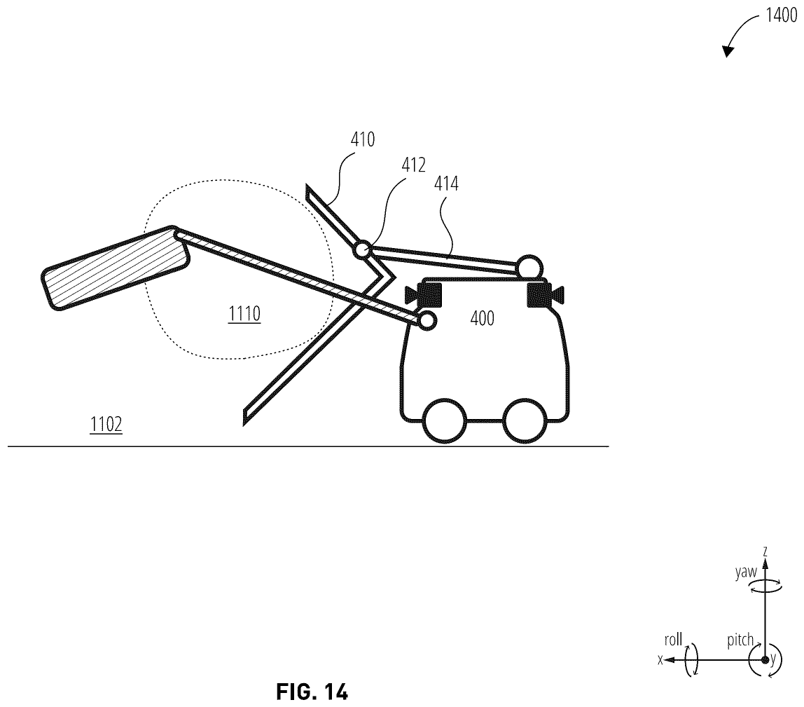

Pad arm pivot points 424, pad pivot points 422, scoop arm pivot points 416 and scoop pivot points 412 (as shown in FIG. 14) may provide the tidying robot 400 a range of motion of these components beyond what is illustrated herein. The positions shown in the disclosed figures are illustrative and not meant to indicate the limits of the robot's component range of motion.

FIG. 11C illustrates a tidying robot 400 with a raised scoop position and raised pusher position 1100c. The pusher pads 418 and pusher pad arms 420 may be in a raised pusher position 1108 while the scoop 410 and scoop arm 414 are in a raised scoop position 1112. In this position, the tidying robot 400 may be able to allow objects drop from the scoop 410 and pusher pad arms 420 to an area at the rear 1114 of the tidying robot 400.

The carrying position may involve the disposition of the pusher pads 418, pusher pad arms 420, scoop 410, and scoop arm 414, in relative configurations between the extremes of lowered scoop position and lowered pusher position 1100a and raised scoop position and raised pusher position 1100c.

FIG. 11D illustrates a tidying robot 400 with pusher pads extended 1100d. By the action of servos or other actuators at the pad pivot points 422, the pusher pads 418 may be configured as extended pusher pads 1116 to allow the tidying robot 400 to approach objects as wide or wider than the robot chassis 402 and scoop 410. In some embodiments, the pusher pads 418 may be able to rotate through almost three hundred and sixty degrees, to rest parallel with and on the outside of their associated pusher pad arms 420 when fully extended.

FIG. 11E illustrates a tidying robot 400 with pusher pads retracted 1100e. The closed pusher pads 1118 may roughly define a containment area 1110 through their position with respect to the scoop 410. In some embodiments, the pusher pads 418 may be able to rotate farther than shown, through almost three hundred and sixty degrees, to rest parallel with and inside of the side walls of the scoop 410.

FIG. 12A-FIG. 12C illustrate a tidying robot 400 such as that introduced with respect to FIG. 4A. In such an embodiment, the pusher pad arms 420 may be controlled by a servo or other actuator at the same point of connection 1202 with the chassis 402 as the scoop arms 414. The tidying robot 400 may be seen disposed in a lowered scoop position and lowered pusher position 1200a, a lowered scoop position and raised pusher position 1200b, and a raised scoop position and raised pusher position 1200c. This tidying robot 400 may be configured to perform the algorithms disclosed herein.

The point of connection shown between the scoop arms 414/pusher pad arms 420 and the chassis 402 is an exemplary position and is not intended to limit the physical location of this point of connection. Such connection may be made in various locations as appropriate to the construction of the chassis 402 and arms, and the applications of intended use.

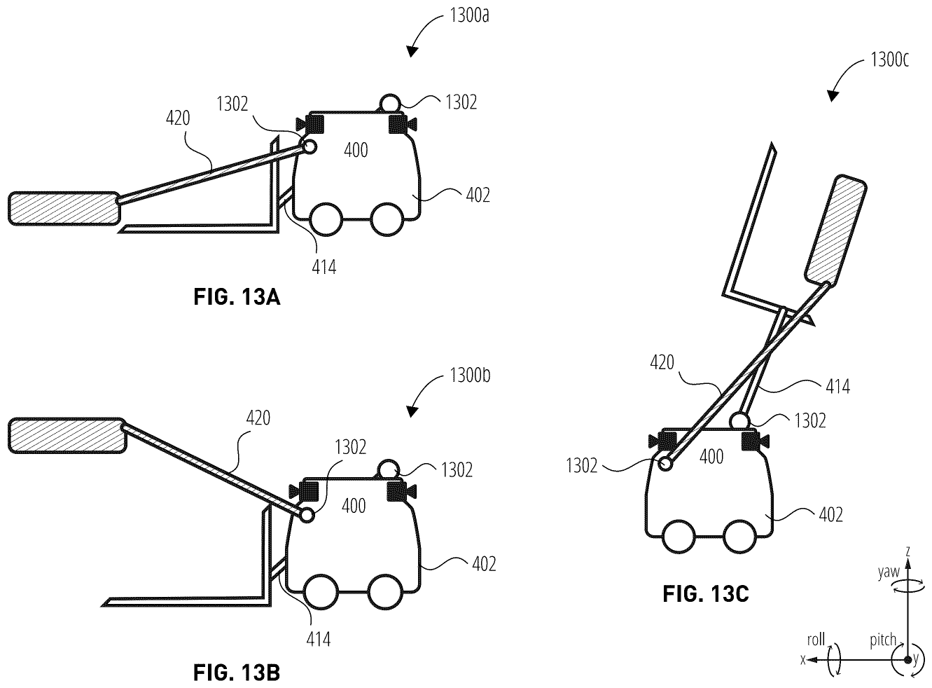

FIG. 13A-FIG. 13C illustrate a tidying robot 400 such as that introduced with respect to FIG. 4A. In such an embodiment, the pusher pad arms 420 may be controlled by a servo or servos (or other actuators) at different points of connection 1302 with the chassis 402 from those controlling the scoop arm 414. The tidying robot 400 may be seen disposed in a lowered scoop position and lowered pusher position 1300a, a lowered scoop position and raised pusher position 1300b, and a raised scoop position and raised pusher position 1300c. This tidying robot 400 may be configured to perform the algorithms disclosed herein.

The different points of connection 1302 between the scoop arm and chassis and the pusher pad arms and chassis shown are exemplary positions and not intended to limit the physical locations of these points of connection. Such connections may be made in various locations as appropriate to the construction of the chassis and arms, and the applications of intended use.

FIG. 14 illustrates a tidying robot 400 such as was previously introduced in a front drop position 1400. The arms of the tidying robot 400 may be positioned to form a containment area 1110 as previously described.

The tidying robot 400 may be configured with a scoop pivot point 412 where the scoop 410 connects to the scoop arm 414. The scoop pivot point 412 may allow the scoop 410 to be tilted forward and down while the scoop arm 414 is raised, allowing objects in the containment area 1110 to slide out and be deposited in an area to the front 1102 of the tidying robot 400.

FIG. 15 illustrates how the positions of the components of the tidying robot 400 may be configured such that the tidying robot 400 may approach an object collection bin 144 and perform a front dump action 1500. The scoop 410 may be raised by scoop arm motor 480, extended by scoop arm linear actuator 472, and tilted by scoop motor 482 so that tidyable objects 1502 carried in the scoop 410 may be deposited into the storage compartment 602 of the object collection bin 144 positioned to the front 1102 of the tidying robot 400, as is also described with respect to the front drop position 1400 of FIG. 14.

FIG. 16 illustrates a tidying robotic system interaction 1600 in accordance with one embodiment. The tidying robotic system may include the tidying robot 400, the base station 600, a robotic control system 1700, and logic 1714 that when executed directs the robot to perform the disclosed method. When the tidying robot 400 is docked at a base station 600 having an object collection bin 144, the scoop 410 may be raised and rotated up and over the tidying robot 400 chassis 402, allowing tidyable objects 1502 in the scoop 410 to drop into the storage compartment 602 of the object collection bin 144 to the rear 1114 of the tidying robot 400 in a rear dump action 1602, as is also described with respect to the raised scoop position and raised pusher position 1100c and raised scoop position and raised pusher position 1200c described with respect to FIG. 11C and FIG. 12C, respectively.

In a docked state, the robot charge connector 460 may electrically couple with the base station charge connector 608 such that electrical power from the power source connection 610 may be carried to the battery 462, and the battery 462 may be recharged toward its maximum capacity for future use.

When the tidying robot 400 docks at its base station 600, the dirt release latch 450 may lower, allowing the vacuum compartment 440 to interface with the vacuum emptying system 612. Where the vacuum emptying system intake port 614 is covered by a protective element, the dirt release latch 450 may interface with that element to open the vacuum emptying system intake port 614 when the tidying robot 400 is docked. The vacuum compartment fan 456 may remain inactive or may reverse direction, permitting or compelling airflow 1604 through the vacuum compartment exhaust port 458, into the vacuum compartment 440, across the dirt collector 448, over the dirt release latch 450, into the vacuum emptying system intake port 614, through the vacuum emptying system filter bag 616, and out the vacuum emptying system exhaust port 622, in conjunction with the operation of the vacuum emptying system fan 618. The action of the vacuum emptying system fan 618 may also pull airflow 1606 in from the vacuum compartment intake port 442, across the dirt collector 448, over the dirt release latch 450, into the vacuum emptying system intake port 614, through the vacuum emptying system filter bag 616, and out the vacuum emptying system exhaust port 622. In combination, airflow 1604 and airflow 1606 may pull dirt and dust from the dirt collector 448 into the vacuum emptying system filter bag 616, emptying the dirt collector 448 for future vacuuming tasks. The vacuum emptying system filter bag 616 may be manually discarded and replaced on a regular basis.

FIG. 17 depicts an embodiment of a robotic control system 1700 to implement components and process steps of the systems described herein. Some or all portions of the robotic control system 1700 and its operational logic may be contained within the physical components of a robot and/or within a cloud server in communication with the robot and/or within the physical components of a user's mobile computing device, such as a smartphone, tablet, laptop, personal digital assistant, or other such mobile computing devices. In one embodiment, aspects of the robotic control system 1700 on a cloud server and/or user's mobile computing device may control more than one robot at a time, allowing multiple robots to work in concert within a working space.

Input devices 1704 (e.g., of a robot or companion device such as a mobile phone or personal computer) comprise transducers that convert physical phenomena into machine internal signals, typically electrical, optical, or magnetic signals. Signals may also be wireless in the form of electromagnetic radiation in the radio frequency (RF) range but also potentially in the infrared or optical range. Examples of input devices 1704 are contact sensors which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 1704 are provided via various machine signal conductors (e.g., busses or network interfaces) and circuits to memory 1706.

The memory 1706 is typically what is known as a first-or second-level memory device, providing for storage (via configuration of matter or states of matter) of signals received from the input devices 1704, instructions and information for controlling operation of the central processing unit or processor 1702, and signals from storage devices 1710. The memory 1706 and/or the storage devices 1710 may store computer-executable instructions and thus forming logic 1714 that when applied to and executed by the processor 1702 implement embodiments of the processes disclosed herein. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic 1714 may include portions of a computer program, along with configuration data, that are run by the processor 1702 or another processor. Logic 1714 may include one or more machine learning models 1716 used to perform the disclosed actions. In one embodiment, portions of the logic 1714 may also reside on a mobile or desktop computing device accessible by a user to facilitate direct user control of the robot.

Information stored in the memory 1706 is typically directly accessible to the processor 1702 of the device. Signals input to the device cause the reconfiguration of the internal material/energy state of the memory 1706, creating in essence a new machine configuration, influencing the behavior of the robotic control system 1700 by configuring the processor 1702 with control signals (instructions) and data provided in conjunction with the control signals.

Second- or third-level storage devices 1710 may provide a slower but higher capacity machine memory capability. Examples of storage devices 1710 are hard disks, optical disks, large-capacity flash memories or other non-volatile memory technologies, and magnetic memories.

In one embodiment, memory 1706 may include virtual storage accessible through a connection with a cloud server using the network interface 1712, as described below. In such embodiments, some or all of the logic 1714 may be stored and processed remotely.

The processor 1702 may cause the configuration of the memory 1706 to be altered by signals in storage devices 1710. In other words, the processor 1702 may cause data and instructions to be read from storage devices 1710 in the memory 1706 which may then influence the operations of processor 1702 as instructions and data signals, and which may also be provided to the output devices 1708. The processor 1702 may alter the content of the memory 1706 by signaling to a machine interface of memory 1706 to alter the internal configuration and then converted signals to the storage devices 1710 alter its material internal configuration. In other words, data and instructions may be backed up from memory 1706, which is often volatile, to storage devices 1710, which are often non-volatile.

Output devices 1708 are transducers that convert signals received from the memory 1706 into physical phenomena such as vibrations in the air, patterns of light on a machine display, vibrations (i.e., haptic devices), or patterns of ink or other materials (i.e., printers and 3-D printers).

The network interface 1712 receives signals from the memory 1706 and converts them into electrical, optical, or wireless signals to other machines, typically via a machine network. The network interface 1712 also receives signals from the machine network and converts them into electrical, optical, or wireless signals to the memory 1706. The network interface 1712 may allow a robot to communicate with a cloud server 1722 containing logic 1714, a mobile device, other robots, and other network-enabled devices.

In one embodiment, a global database 1718 may provide data storage available across the devices that comprise or are supported by the robotic control system 1700. The global database 1718 may include maps, robotic instruction algorithms, robot state information, static, movable, and tidyable object reidentification fingerprints, labels, and other data associated with known static, movable, and tidyable object reidentification fingerprints, or other data supporting the implementation of the disclosed solution. The global database 1718 may be a single data structure or may be distributed across more than one data structure and storage platform, as may best suit an implementation of the disclosed solution. In one embodiment, the global database 1718 is coupled to other components of the robotic control system 1700 through a wired or wireless network, and in communication with the network interface 1712.

In one embodiment, a robot instruction database 1720 may provide data storage available across the devices that comprise or are supported by the robotic control system 1700. The robot instruction database 1720 may include the programmatic routines that direct specific actuators of the tidying robot, such as are described previously, to actuate and cease actuation in sequences that allow the tidying robot to perform individual and aggregate motions to complete tasks.

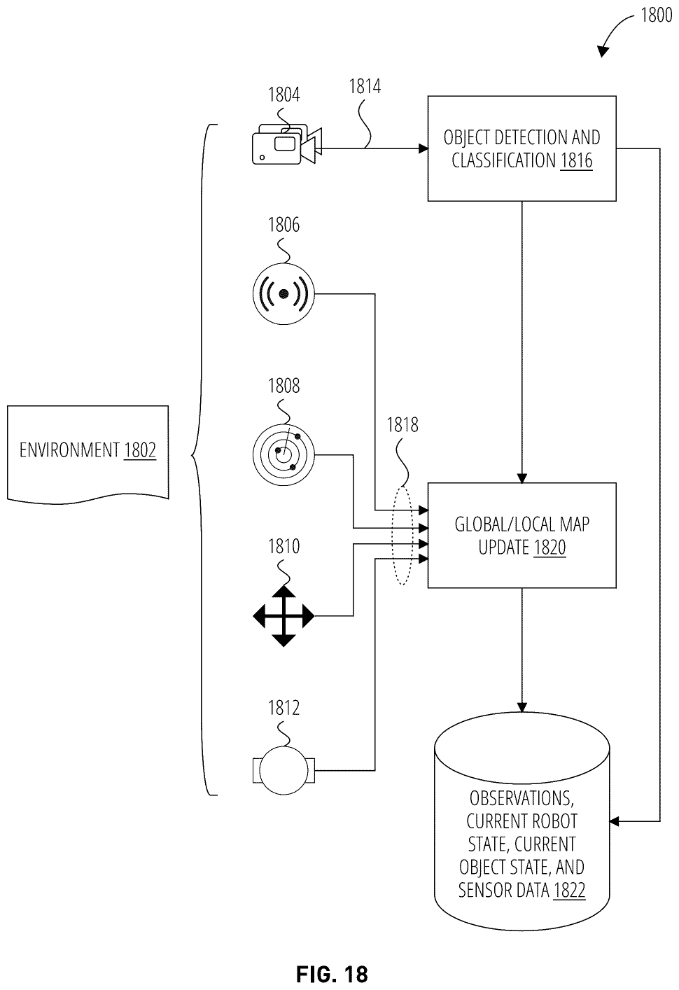

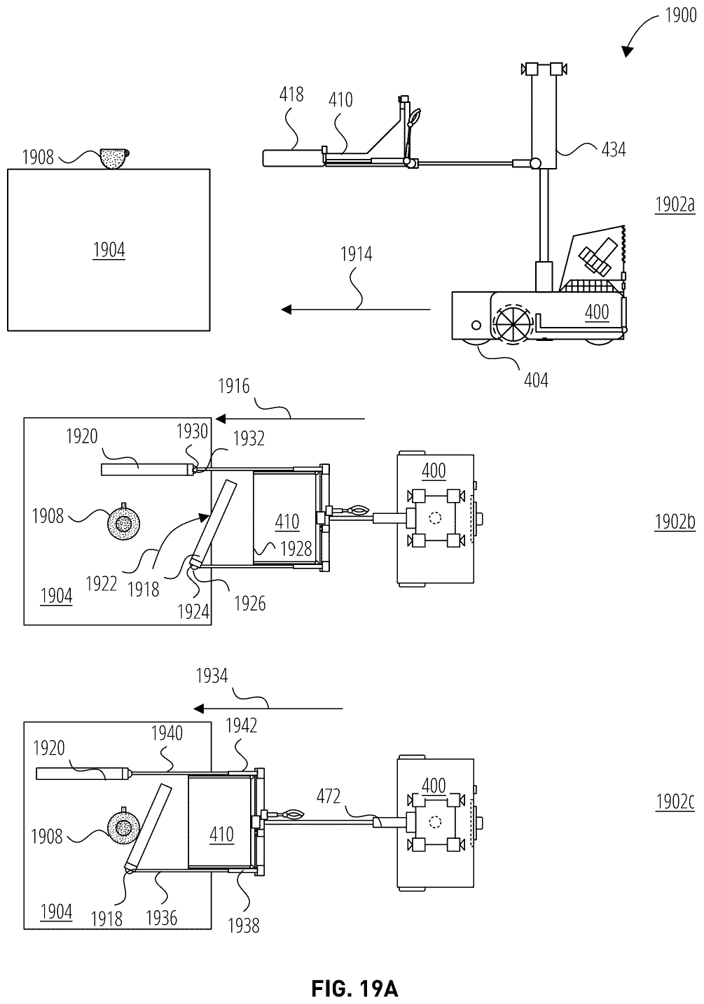

FIG. 18 illustrates sensor input analysis 1800 in accordance with one embodiment. Sensor input analysis 1800 may inform the tidying robot 400 of the dimensions of its immediate environment 1802 and the location of itself and other objects within that environment 1802.

The tidying robot 400 as previously described includes a sensing system 406. This sensing system 406 may include at least one of cameras 1804, IMU sensors 1806, lidar sensor 1808, odometry 1810, and actuator force feedback sensor 1812. These sensors may capture data describing the environment 1802 around the tidying robot 400.

Image data 1814 from the cameras 1804 may be used for object detection and classification 1816. Object detection and classification 1816 may be performed by algorithms and models configured within the robotic control system 1700 of the tidying robot 400. In this manner, the characteristics and types of objects in the environment 1802 may be determined.

Image data 1814, object detection and classification 1816 data, and other sensor data 1818 may be used for a global/local map update 1820. The global and/or local map may be stored by the tidying robot 400 and may represent its knowledge of the dimensions and objects within its decluttering environment 1802. This map may be used in navigation and strategy determination associated with decluttering tasks.

The tidying robot 400 may use a combination of camera 1804, lidar sensor 1808 and the other sensors to maintain a global or local area map of the environment and to localize itself within that. Additionally, the robot may perform object detection and object classification and may generate visual re-identification fingerprints for each object. The robot may utilize stereo cameras along with a machine learning/neural network software architecture (e.g., semi-supervised or supervised convolutional neural network) to efficiently classify the type, size and location of different objects on a map of the environment.

The robot may determine the relative distance and angle to each object. The distance and angle may then be used to localize objects on the global or local area map. The robot may utilize both forward and backward facing cameras to scan both to the front and to the rear of the robot.

image data 1814, object detection and classification 1816 data, other sensor data 1818, and global/local map update 1820 data may be stored as observations, current robot state, current object state, and sensor data 1822. The observations, current robot state, current object state, and sensor data 1822 may be used by the robotic control system 1700 of the tidying robot 400 in determining navigation paths and task strategies.

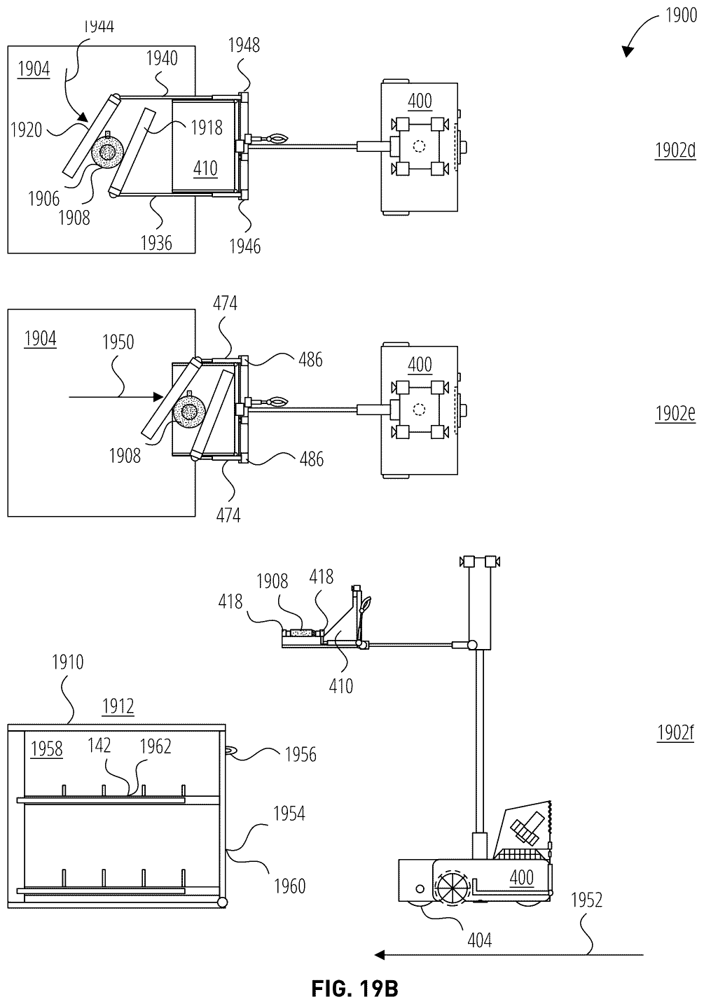

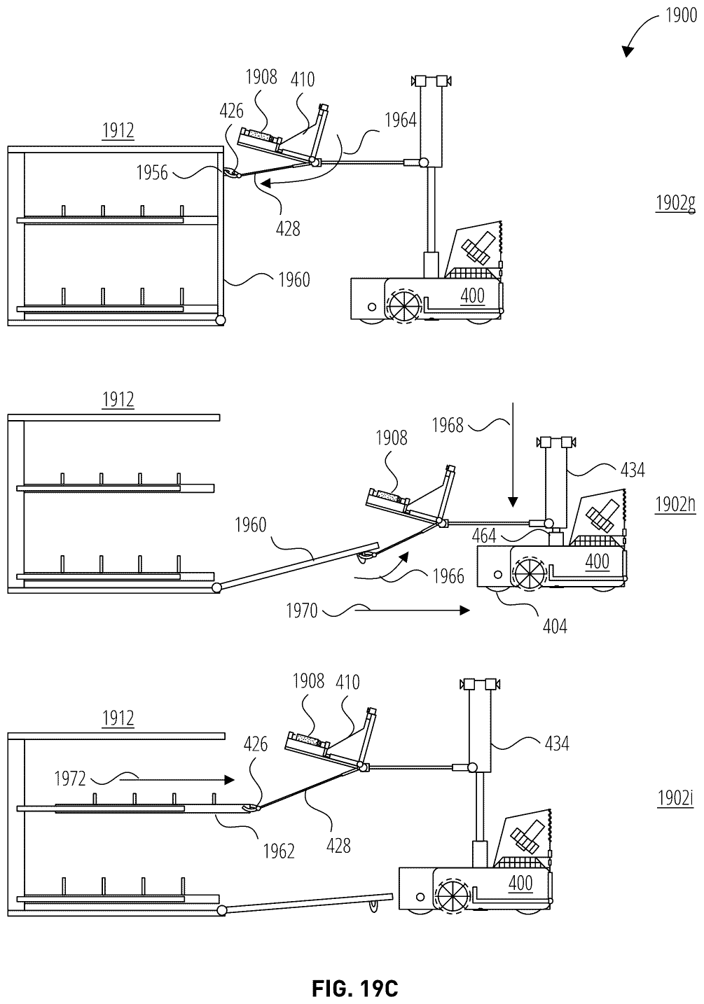

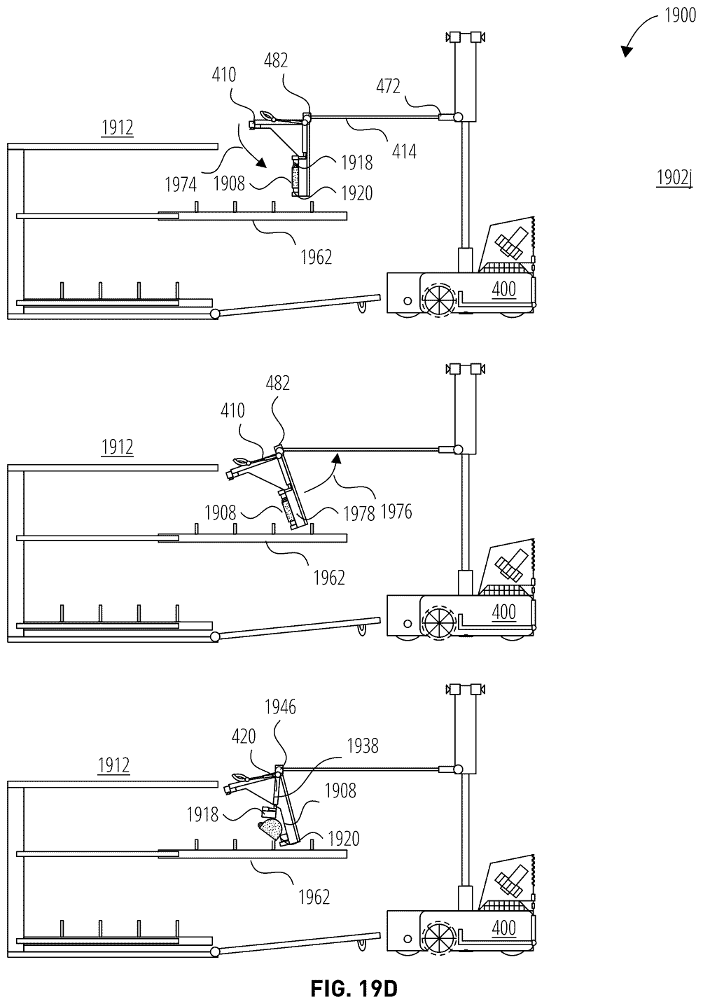

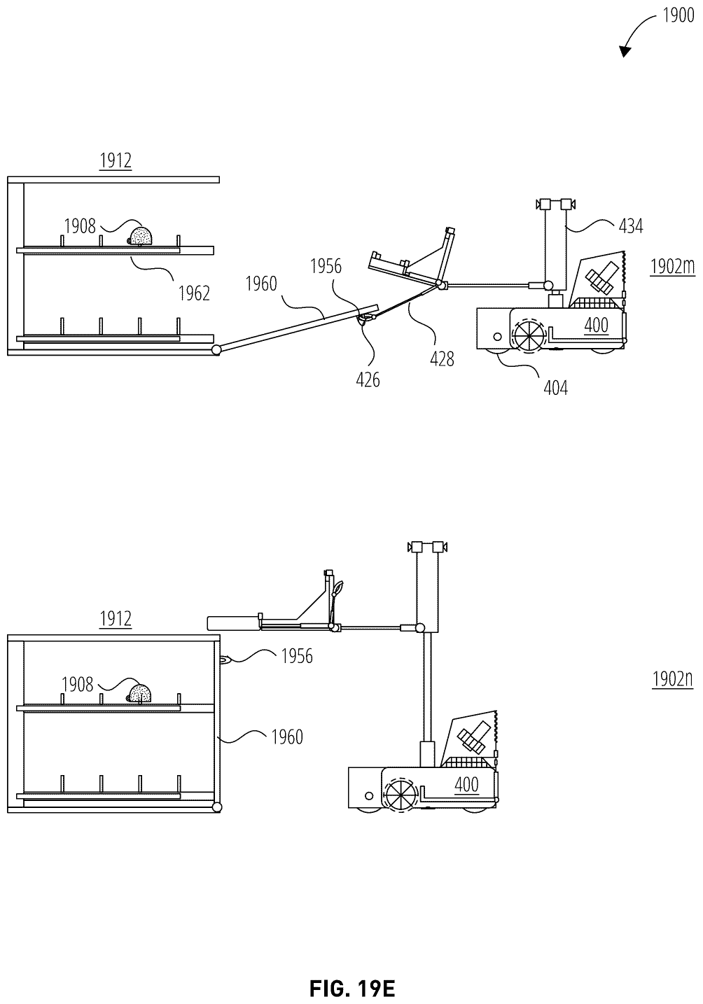

FIG. 19A-FIG. 19E illustrate an obstruction placement procedure 1900 in accordance with one embodiment. Steps 1902a-1902n illustrate the actions a tidying robot 400 may take to approach a tabletop or countertop 1904, remove an obstruction 1906 such as a dirty cup 1908, and place it at a destination 1910, such as a dishwasher 1912. In step 1902a, the tidying robot 400 may approach 1914 the countertop 1904 through the action of the mobility system 404. The tidying robot 400 may have its pusher pads 418 extended in front of the scoop 410. The lifting column 434 may be elevated such that the bottom of the scoop 410 is level with and slightly above the top of the countertop 1904.

In step 1902b, the tidying robot 400 may continue to approach 1916 the countertop 1904 and the cup 1908 with the first pusher pad 1918 rotated inward 1922 at a first pad pivot point 1924 by a first pusher pad motor 1926 toward the front edge 1928 of the scoop 410, and parallel to or angled toward that front edge 1928. The second pusher pad 1920 may be open and pointing forward as shown or may be rotated outward at a second pad pivot point 1930 by a second pusher pad motor 1932 to be further away from the scoop 410 front edge 1928. In step 1902c, the tidying robot 400 may drive forward or may extend 1934 the scoop arm linear actuator 472, and/or the first pusher pad arm 1936 using the first pusher pad arm linear actuator 1938 and the second pusher pad arm 1940 using the second pusher pad arm linear actuator 1942, horizontally forward until the cup 1908 is in contact with the first pusher pad 1918.

In step 1902d, the tidying robot 400 may close 1944 the second pusher pad 1920 so that the cup 1908 is held firmly between the first pusher pad 1918 and the second pusher pad 1920. The first pusher pad arm motor 1946 at the base of the first pusher pad arm 1936 and the second pusher pad arm motor 1948 at the base of the second pusher pad arm 1940 may be rotated to lift the cup 1908 slightly up and off of the countertop 1904. The cup 1908 may be positioned slightly above the level of the front edge 1928 of the scoop 410. In step 1902e, the pusher pad arm linear actuators 474 may retract 1950 so that the cup 1908 passes above the front edge 1928 into an area fully above the scoop 410. The first and second pusher pad arm motors 486 may rotate to lower the cup 1908 onto the scoop 410.

In step 1902f, the tidying robot 400 may plan and execute an approach path 1952, using the mobility system 404 to drive from the countertop 1904 to the destination 1910, such as the dishwasher 1912. The destination 1910 may have an access panel 1954 with a handle 1956 allowing access to an interior of the destination 1958, such as a dishwasher door 1960. The destination 1910 may include storage platforms 142 such as dishwasher trays 1962. During path planning and navigation, the tidying robot 400 may hold the cup 1908 securely in the scoop 410 with the pusher pads 418. In step 1902g, the tidying robot 400 may rotate and extend 1964 the gripper arm 428 underneath the scoop 410 so that the gripper arm 428 or actuated gripper 426 may grab the handle 1956 of the dishwasher door 1960.

In step 1902h, the tidying robot 400 may retract and potentially rotate 1966 the gripper arm 428 to begin opening the dishwasher 1912. The tidying robot 400 may then retract the lifting column linear actuator 464 to lower 1968 the lifting column 434 while backing up 1970 using its mobility system 404 to fully open the dishwasher door 1960. In step 1902i, the tidying robot 400 may use the gripper arm 428 or actuated gripper 426 to pull out 1972 one of the dishwasher trays 1962 while still holding the cup 1908 securely in the scoop 410. This action may be performed through similar forward and backward motions of the tidying robot 400 along with extension, retraction, and rotation of the gripper arm 428, raising and lowering of the lifting column 434, etc.

In step 1902j, the tidying robot 400 may extend the scoop arm linear actuator 472 of the scoop arm 414 so that the scoop 410 is over the dishwasher tray 1962. The scoop motor 482 may rotate 1976 so that the scoop 410 begins to invert 1974. At this time, the first pusher pad 1918 and second pusher pad 1920 may still apply firm pressure to the cup 1908. In step 1902k, the scoop motor 482 may continue to rotate 1976 the scoop 410 so that the cup 1908 is held in a partially inverted position 1978 slightly above the dishwasher tray 1962 while the cup is still held securely in the scoop 410.

In step 1902l, the first pusher pad 1918 may rotate slightly through the action of its first pusher pad arm motor 1946, and the first pusher pad arm linear actuator 1938 may extend slightly as shown, moving the cup 1908 slowly out of the scoop 410 and onto the dishwasher tray 1962. The first pusher pad 1918 and second pusher pad 1920 may maintain firm pressure on the cup 1908 as it is being moved to keep its motion steady and controlled. In step 1902m, the cup 1908 may now rest safely on the dishwasher tray 1962. The tidying robot 400 may push the dishwasher tray 1962 back into the dishwasher 1912 and close the dishwasher door 1960 through coordinated operation of the mobility system 404, gripper arm 428, lifting column 434, etc., in a manner similar to the steps previously described.

In step 1902n, now that the cup 1908 is in the dishwasher 1912, the dishwasher door 1960 is closed, and the handle 1956 is released, the tidying robot 400 may plan a path to return to the countertop to pick up another dish to put in the dishwasher 1912, to navigate to a base station, or to perform other tidying tasks. Once the dishwasher 1912 has completed washing the cup 1908, it may be removed from the dishwasher 1912 using steps similar to those implemented to remove the cup 1908 from the countertop 1904.

One of ordinary skill in the art will appreciate that, while the first pusher pad is shown here to be the left pusher pad and the second pusher pad is illustrated as the right pusher pad, the actions described here and elsewhere in this disclosure may be performed as readily with the right pusher pad being the first and the left the second. The designations “first,” “second,” “right,” and “left” used herein are not intended to limit the performance of these actions to a specifically sided sequence of motion for the tidying robot 400.

FIG. 20A-FIG. 20E illustrate an obstruction placement procedure 2000 in accordance with one embodiment. In steps 2002a-2002k of this process, a tidying robot 400 may operate to approach a destination 1910 with access panels 1954 having handles 1956 allowing access to an interior of the destination 1958, as well as storage platforms 142, such as cabinet 2004 having handled cabinet doors 2006 and shelves 2008 for storing portable bins 2010. The portable bins 2010 may be configured to be lifted and carried by the tidying robot 400. The portable bins 2010 may be configured for carrying by the tidying robot 400.

In step 2002a, the tidying robot 400 may approach a cabinet 2004 or closet having closed cabinet doors 2006, behind which are stored portable bins 2010 on shelves 2008. The lifting column 434 may be raised to a height appropriate to engage with a desired cabinet door 2006 handle 1956 of the cabinet 2004. In step 2002b, the tidying robot 400 may extend its gripper arm 428 toward the handle 1956 of the desired cabinet door 2006. The tidying robot 400 may follow an algorithm to explore the cabinet 2004 and identify different portable bins 2010 and their locations within it to detect the correct one, may store a lookup table of specific portable bin 2010 locations, etc.

In step 2002c, the gripper arm 428 (or actuated gripper 426) may engage with and close around the cabinet door 2006 handle 1956 in order to grasp it. In step 2002d, the gripper arm linear actuator 476 may retract, the scoop arm linear actuator 472 may retract, or the tidying robot 400 may drive backwards to open the cabinet door 2006. Note that the base of the gripper arm 428 may allow some deflection (e.g., by incorporating a spring) as the cabinet door 2006 likely rotates while opening. The tidying robot 400 may also turn in its entirety or the lifting column 434 may rotate slightly to account for the rotation of the opening cabinet door 2006.

In step 2002e, the movable scoop walls 2012 may rotate back into the scoop 410 or otherwise out of the way so that sides of the scoop 410 don't interfere with the scoop 410 passing beneath portable bins 2010. Similarly, the gripper arm 428 and pusher pads 418 may be moved so as to avoid obstructing engagement of the scoop 410 with the portable bin 2010. In this position, the scoop 410 may be considered to be in a “forklift” configuration (forklift configuration 2014) for engaging with the desired portable bin 2010. In step 2002f, the tidying robot 400 may extend the scoop arm linear actuator 472 or may drive forward so that the scoop 410 passes beneath the portable bin 2010 in the cabinet 2004. The lifting column linear actuator 464 may be extended to lift the portable bin 2010 slightly up off of the cabinet 2004 shelf 2008.

In one embodiment, the portable bin 2010 may have a scoop slot 2016 that includes a scoop slot opening 2018. The scoop slot opening 2018 may allow the scoop 410 to pass into the scoop slot 2016, and the scoop slot 2016 may allow the portable bin 2010 to remain engaged with the scoop 410 as the scoop 410 is manipulated into various positions and orientations. In step 2002f, the scoop arm linear actuator 472 may extend and insert the scoop 410 into the scoop slot opening 2018 until a known position is reached or a force detector detects resistance indicating that the scoop 410 is fully seated within the scoop slot 2016.

In step 2002g, the tidying robot 400 may back away from the cabinet 2004 and/or retract the scoop arm linear actuator 472, moving the portable bin 2010 out of the cabinet 2004. In step 2002h, the tidying robot 400 may tilt the scoop 410 up and back while extending the gripper arm 428 to grasp the cabinet door 2006. The tidying robot 400 may then close the cabinet door 2006 by pushing with the gripper arm 428.

In step 2002i, after closing the cabinet door 2006, the tidying robot 400 may drive away while carrying the portable bin 2010. In step 2002j, the tidying robot 400 may lower the portable bin 2010 onto the floor 2020. The portable bin 2010 may also be placed by the tidying robot 400 onto a table, a countertop, or other stable, flat surface 2022. In step 2002k, the tidying robot 400 may back up, leaving the portable bin 2010 on the floor 2020 or other surface. The portable bin 2010 may include legs or a slot under it so the tidying robot 400 may easily remove its scoop 410 from under the portable bin 2010.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to. ” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

What is claimed is:

1. A sanitizing station for a tidying robot, the sanitizing station comprising:
a sanitizing chamber with a water-tight door, wherein the sanitizing chamber is configured to receive at least one end effector of the tidying robot, wherein the at least one end effector includes a scoop, pusher pads, pusher pad arms, and a gripper arm;
a water reservoir with a water intake;
a water heater configured to heat sanitizing fluids in the water reservoir;
a drain configured to drain water from the water reservoir;
a recirculation pump in fluid communication with the drain and configured to pump water through water spray nozzles;
the water spray nozzles configured to spray sanitizing fluids into the sanitizing chamber;
a detergent dispenser configured to apply detergent to the at least one end effector in the sanitizing chamber;
a wastewater filter configured to filter sanitizing fluids entering the water reservoir from the sanitizing chamber;
a wastewater pump in fluid communication with the drain and a wastewater outlet;
a drying air intake in fluid communication with a drying fan, configured to draw in drying air;
drying air conduits in fluid communication with the drying fan and the sanitizing chamber; and
an air outlet conduit in fluid communication with the sanitizing chamber and a drying air outlet.

2. The sanitizing station of claim 1, further comprising an air heater, downstream of the drying air intake, configured to heat the drying air.

3. The sanitizing station of claim 1, further comprising a vacuum emptying system including:
a vacuum emptying system intake port configured to allow vacuum emptying airflow to enter the vacuum emptying system and to place a robot vacuum compartment in the tidying robot in fluid communication with the vacuum emptying system intake port;
a vacuum emptying system fan driven by a vacuum emptying system motor to create the vacuum emptying airflow from the vacuum emptying system intake port to a vacuum emptying system exhaust port; and
at least one of:
a vacuum emptying system filter;
a vacuum emptying system dirt collecting bag; and
a vacuum emptying system filter bag.

4. The sanitizing station of claim 1, further comprising object collection bins above the sanitizing chamber.

5. The sanitizing station of claim 1, further comprising a base station charge connector configured to charge the tidying robot while the tidying robot is docked with the sanitizing station.

6. The sanitizing station of claim 1, further comprising a bin storage cabinet alongside the sanitizing chamber.

7. The sanitizing station of claim 1, further comprising a door motor connected to the water-tight door to slide or rotate the water-tight door to an open position.

8. A method comprising:
opening, with at least one end effector of a tidying robot, a water-tight door of a sanitizing station, wherein the sanitizing station includes:
a sanitizing chamber with the water-tight door, wherein the sanitizing chamber is configured to receive the at least one end effector of the tidying robot, wherein the at least one end effector includes a scoop, pusher pads, pusher pad arms, and a gripper arm;
a water reservoir with a water intake;
a water heater configured to heat sanitizing fluids in the water reservoir;
a drain configured to drain sanitizing fluids from the water reservoir;
a recirculation pump in fluid communication with the drain and configured to pump sanitizing fluids through water spray nozzles;
the water spray nozzles configured to spray sanitizing fluids into the sanitizing chamber;
a detergent dispenser configured to apply detergent to the at least one end effector in the sanitizing chamber;
a wastewater filter configured to filter sanitizing fluids entering the water reservoir from the sanitizing chamber;
a wastewater pump in fluid communication with the drain and a wastewater outlet;
a drying air intake in fluid communication with a drying fan, configured to draw in drying air;
drying air conduits in fluid communication with the drying fan and the sanitizing chamber; and
an air outlet conduit in fluid communication with the sanitizing chamber and a drying air outlet;
docking the tidying robot with the sanitizing station;
placing the at least one end effector into the sanitizing chamber;
closing the water-tight door;
initiating a sanitization cycle, the sanitation cycle including:
filling the water reservoir with sanitizing fluids;
heating the sanitizing fluids;
dispensing detergent into the sanitizing chamber;
spraying, using the water spray nozzles, sanitizing fluids on the at least one end effector;
draining the sanitizing fluids from the water reservoir; and
initiating a drying cycle using the drying fan to circulate drying air.

9. The method of claim 8, further comprising removing the sanitizing fluids from the at least one end effector, comprising;
initiating a rinse cycle including:
filling the water reservoir;
spraying water, using the water spray nozzles, on the at least one end effector; and
draining the water from the water reservoir.

10. The method of claim 8, further comprising:
opening the water-tight door; and
removing the at least one end effector from the sanitizing chamber.

11. The method of claim 10, wherein opening the water-tight door includes operating a door motor connected to the water-tight door to slide or rotate the water-tight door to an open position.

12. The method of claim 8, further comprising heating the drying air with an air heater, downstream of the drying air intake.

13. The method of claim 8, wherein docking of the tidying robot includes connecting to a base station charge connector configured to charge the tidying robot.

14. The method of claim 8, wherein docking of the tidying robot includes placing a robot vacuum compartment in the tidying robot in fluid communication with a vacuum emptying system on the sanitizing station.

15. The method of claim 14, further comprising initiating the vacuum emptying system including energizing a vacuum emptying system motor, the vacuum emptying system including:
a vacuum emptying system intake port configured to allow vacuum emptying airflow to enter the vacuum emptying system and to place the robot vacuum compartment in the tidying robot in fluid communication with the vacuum emptying system intake port;
a vacuum emptying system fan driven by the vacuum emptying system motor to create the vacuum emptying airflow from the vacuum emptying system intake port to a vacuum emptying system exhaust port; and
at least one of:
a vacuum emptying system filter;
a vacuum emptying system dirt collecting bag; and
a vacuum emptying system filter bag;
removing debris from at least one of the vacuum emptying system filter, the vacuum emptying system dirt collecting bag and the vacuum emptying system filter bag;
stopping the vacuum emptying system motor; and
undocking the tidying robot from the sanitizing station.

16. The method of claim 8, further comprising:
approaching, with the tidying robot, a bin storage cabinet alongside the sanitizing chamber, wherein the at least one end effector includes at least one tidyable object;
opening a drawer of the bin storage cabinet with the at least one end effector, wherein the drawer includes an object collection bin;
depositing the at least one tidyable object into the object collection bin; and
closing the drawer with the at least one end effector.

17. The method of claim 16, further comprising:
removing the at least one end effector;
placing the removed at least one end effector into the object collection bin, wherein the object collection bin contains at least one different end effector; and
placing the at least one different end effector on the tidying robot.
